(19) United States
(12) Patent Application Publication
(10) Pub. No.: US 2016/0053140 A1
(43) Pub. Date: Feb. 25, 2016

(54) DOUBLE-SIDED PRESSURE-SENSITIVE ADHESIVE SHEET, LAMINATE AND METHOD FOR PEELING PLATES

(71) Applicant: NITTO DENKO CORPORATION, Osaka (JP)

(72) Inventors: Masahito NIWA, Osaka (JP); Kaori MIKI, Osaka (JP); Masato FUJITA, Osaka (JP); Takahiro NONAKA, Osaka (JP)

(73) Assignee: NITTO DENKO CORPORATION, Osaka (JP)

(21) Appl. No.: 14/840,575

(22) Filed: Aug. 31, 2015

Related U.S. Application Data
(62) Division of application No. 14/014,580, filed on Aug. 30, 2013, now abandoned.

(30) Foreign Application Priority Data
Aug. 30, 2012 (JP) 2012-189612

(51) Int. Cl. C09J 133/08; B32B 43/00; C09J 7/02

(52) U.S. Cl. CPC C09J 133/08; C09J 7/0217; B32B 43/006; C09J 2433/00; B32B 2457/202; B32B 2367/00

(57) ABSTRACT

A double-sided pressure-sensitive adhesive sheet includes a pressure-sensitive adhesive layer containing an acrylic polymer formed of a component comprising, as an essential monomer component, an alkyl (meth)acrylate having an alkyl group having 9 or less carbon atoms. A shear storage elastic modulus at 23° C. of the pressure-sensitive adhesive layer, which is measured by dynamic viscoelasticity measurement, is 5.0×10⁵ Pa or less, and a shear storage elastic modulus at −50° C. of the pressure-sensitive adhesive layer, which is measured by dynamic viscoelasticity measurement, is 1.0×10⁸ Pa or more.

This is a divisional of U.S. application Ser. No. 14/014,580 filed Aug. 30, 2013, which claims priority from Japanese Application No. 2012-189612 filed on Aug. 30, 2012, the contents of all of which are hereby incorporated by reference into this application.

### BACKGROUND OF THE INVENTION

1. Technical Field

The present invention relates to a double-sided pressure-sensitive adhesive sheet. The present invention also relates to a laminate in which the double-sided pressure-sensitive adhesive sheet is laminated to an optical member. The present invention also relates to a method for peeling two plates which are laminated through the double-sided pressure-sensitive adhesive sheet.

2. Background Art

Recently, in various fields, display devices such as a liquid crystal display (LCD) or an input device used by combining with the display device, such as a touch panel, has been widely used. In the manufacture of the display device or the input device, a transparent pressure-sensitive adhesive sheet is used for laminating an optical member. For example, a double-sided pressure-sensitive adhesive sheet is used for laminating the touch panel or lens to the liquid crystal display (LCD or the like) (for example, see Patent Documents 1 to 3).

Patent Document 1: JP-A-2003-238915

Patent Document 2: JP-A-2003-342542

Patent Document 3: JP-A-2004-231723

### SUMMARY OF THE INVENTION

Regarding the pressure-sensitive adhesive sheets to be used for the above-mentioned purposes, the following demands have increased: the pressure-sensitive adhesive property is excellent after optical members are laminated to each other; and the optical members once laminated can be reworked (removed) when they are needed to be re-laminated. In particular, the following demands have increased: the pressure-sensitive adhesive property at room temperature is excellent; and they can be reworked at a low temperature.

The above removal property (reworkability) is demanded not only for the use of the removal of optical members, but also for various uses.

An object of the present invention is to provide a double-sided pressure-sensitive adhesive sheet including a pressure-sensitive adhesive layer, which is excellent in the pressure-sensitive adhesive property at room temperature and reworkability (removability) at a low temperature.

As a result of the intensive studies, the present inventors have found that a double-sided pressure-sensitive adhesive sheet including a pressure-sensitive adhesive sheet including an acrylic polymer formed of a monomer component including a specific monomer, wherein the pressure-sensitive adhesive sheet has a shear storage elastic modulus at 23° C. and a shear storage elastic modulus at −50° C., which are measured by dynamic viscoelasticity measurement, within a specific range, respectively, is excellent in the pressure-sensitive adhesive property at room temperature and reworkability at a low temperature, and thus, the present invention has been accomplished.

The present invention provides the following double-sided pressure-sensitive adhesive sheet, laminate and method for peeling plates.

(1) A double-sided pressure-sensitive adhesive sheet, comprising a pressure-sensitive adhesive layer containing an acrylic polymer formed of a component comprising, as an essential monomer component, an alkyl (meth)acrylate having an alkyl group having 9 or less carbon atoms,

wherein a shear storage elastic modulus at 23° C. of the pressure-sensitive adhesive layer, which is measured by dynamic viscoelasticity measurement, is 5.0×10⁵ Pa or less, and a shear storage elastic modulus at −50° C. of the pressure-sensitive adhesive layer, which is measured by dynamic viscoelasticity measurement, is 1.0×10⁸ Pa or more.

(2) The double-sided pressure-sensitive adhesive sheet according to (1), wherein the shear storage elastic modulus at 23° C. of the pressure-sensitive adhesive layer, which is measured by dynamic viscoelasticity measurement, is 1.0×10⁴ Pa or more.

(3) The double-sided pressure-sensitive adhesive sheet according to (1) or (2), wherein the shear storage elastic modulus at −50° C. of the pressure-sensitive adhesive layer, which is measured by dynamic viscoelasticity measurement, is 1.0×10¹⁰ Pa or less.

(4) The double-sided pressure-sensitive adhesive sheet according to any one of (1) to (3), wherein a peel force measured by the following film T-type peel test is 3 N or less:

Film T-type peel test: one pressure-sensitive adhesive surface of the double-sided pressure-sensitive adhesive sheet (size of 150 mm length×20 mm width) and a surface of a polyethylene terephthalate film (size of 150 mm length×20 mm width) are laminated, and the other pressure-sensitive adhesive surface of the double-sided pressure-sensitive adhesive sheet and a surface of a polyethylene terephthalate film (size of 150 mm length×20 mm width) are laminated, thereby preparing a test piece having a configuration of the polyethylene terephthalate film/the double-sided pressure-sensitive adhesive sheet/the polyethylene terephthalate film; the test piece is treated under the conditions of a temperature of 50° C. and a pressure of 5 atm for 15 minutes, and then, the test piece is allowed to stand for 30 minutes under the environment of a temperature of −50° C.; and after that, the test piece is subjected to T-type peel under the conditions of a temperature of −50° C. and a tensile speed of 300 mm/min, to measure the peel force.

(5) The double-sided pressure-sensitive adhesive sheet according to (4), wherein the peel force measured by the film T-type peel test is 0.01 N or more

(6) The double-sided pressure-sensitive adhesive sheet according to (4) or (5), which is capable of being peeled from an adherend by the peel force of 0.01 to 3 N, which is measured by the film T-type peel test, at a temperature, at which the shear storage elastic modulus of the pressure-sensitive adhesive layer, which is measured by the dynamic viscoelasticity measurement, is 1.0×10⁸ Pa or more.

(7) The double-sided pressure-sensitive adhesive sheet according to (4) or (5), which is capable of being peeled from an adherend by the peel force of 0.01 to 3 N, which is measured by the film T-type peel test, at a temperature, at which the shear storage elastic modulus of the pressure-sensitive adhesive layer, which is measured by the dynamic viscoelasticity measurement, is 1.0×10⁸ Pa or more and 1.0×10¹⁰ Pa or less.

(8) The double-sided pressure-sensitive adhesive sheet according to any one of (1) to (7), wherein the component to form the acrylic polymer comprises 1 to 40 wt % of an alicyclic monomer.

(9) The double-sided pressure-sensitive adhesive sheet according to any one of (1) to (8), wherein the component to form the acrylic polymer comprises 5 to 50 wt % of a polar group-containing monomer.

(10) The double-sided pressure-sensitive adhesive sheet according to (9), wherein the polar group-containing monomer is selected from the group consisting of: a combination of a hydroxyl group-containing monomer and a hetero ring-containing vinyl monomer; a nitrogen atom-containing monomer; and a carboxyl group-containing monomer.

(11) The double-sided pressure-sensitive adhesive sheet according to any one of (1) to (7), wherein the component to form the acrylic polymer comprises, based on a total amount (100 wt %) of the monomer component, 65 to 70 wt % of the alkyl (meth)acrylate having an alkyl group having 9 or less carbon atoms, 17 to 22 wt % of a nitrogen-atom containing monomer, and 8 to 13 wt % of an alicyclic monomer.

(12) The double-sided pressure-sensitive adhesive sheet according to any one of (1) to (7), wherein the component to form the acrylic polymer comprises, based on a total amount (100 wt %) of the monomer component, 65 to 70 wt % of the alkyl (meth)acrylate having an alkyl group having 9 or less carbon atoms, 15 to 20 wt % of a hydroxyl group-containing monomer, and 10 to 15 wt % of a nitrogen atom-containing monomer

(13) The double-sided pressure-sensitive adhesive sheet according to any one of (1) to (7), wherein the component to form the acrylic polymer comprises, based on a total amount (100 wt %) of the monomer component, 87 to 92 wt % of the alkyl (meth)acrylate having an alkyl group having 9 or less carbon atoms, 8 to 13 wt % of a carboxyl group-containing monomer.

(14) The double-sided pressure-sensitive adhesive sheet according to any one of (1) to (7), wherein the component to form the acrylic polymer comprises, based on a total amount (100 wt %) of the monomer component, 70 to 80 wt % of the alkyl (meth)acrylate having an alkyl group having 9 or less carbon atoms, and 20 to 30 wt % of a nitrogen atom-containing monomer.

(15) A laminate, comprising the double-sided pressure-sensitive adhesive sheet according to any one of (1) to (14) and an optical member, wherein the double-sided pressure-sensitive adhesive sheet is laminated to the optical member.

(16) A method for peeling two plates laminated through a double-sided pressure-sensitive adhesive sheet,

wherein the double-sided pressure-sensitive adhesive sheet comprises a pressure-sensitive adhesive layer containing an acrylic polymer formed of a component comprising, as an essential monomer component, an alkyl (meth)acrylate having an alkyl group having 9 or less carbon atoms, wherein a shear storage elastic modulus at 23° C. of the pressure-sensitive adhesive layer, which is measured by dynamic viscoelasticity measurement, is 5.0×10⁵ Pa or less, and a shear storage elastic modulus at −50° C. of the pressure-sensitive adhesive layer, which is measured by dynamic viscoelasticity measurement, is 1.0×10⁸ Pa or more, and

the method comprises peeling at least one plate of the two plates at a temperature, at which the shear storage elastic modulus of the pressure-sensitive adhesive layer, which is measured by the dynamic viscoelasticity measurement, is 1.0×10⁸ Pa or more.

(17) The method according to (16), wherein the shear storage elastic modulus at 23° C. of the pressure-sensitive adhesive layer, which is measured by dynamic viscoelasticity measurement, is 1.0×10⁴ Pa or more.

(18) The method according to (16) or (17), wherein the shear storage elastic modulus at −50° C. of the pressure-sensitive adhesive layer, which is measured by dynamic viscoelasticity measurement, is 1.0×10¹⁰ Pa or less.

(19) The method according to any one of (16) to (18), wherein the method comprises peeling at least one plate of the two plates at a temperature, at which the shear storage elastic modulus of the pressure-sensitive adhesive layer, which is measured by the dynamic viscoelasticity measurement, is 1.0×10⁸ Pa or more and 1.0×10¹⁰ Pa or less.

The double-sided pressure-sensitive adhesive sheet of the present invention has the above constitutional features, and thus, the double-sided pressure-sensitive adhesive sheet is excellent in the pressure-sensitive adhesive property at room temperature and reworkability at a low temperature.

### BRIEF DESCRIPTION OF THE DRAWINGS

FIGS. 1(a) to 1(c) are a diagram showing an example of a force applying method A.

FIG. 2 is a diagram showing an example of a force applying method B.

FIG. 3 is a diagram showing an example of a force applying method B.

FIG. 4 is a diagram showing an example of a force applying method C.

FIG. 5 is an explanatory view (cross-sectional view) showing a test sample used in a film T-type peel test.

FIG. 6 is an explanatory view (plan view) showing a test sample used in a film T-type peel test.

### DETAILED DESCRIPTION OF THE INVENTION

(1) Double-Sided Pressure-Sensitive Adhesive Sheet

A double-sided pressure-sensitive adhesive sheet of the present invention includes at least one pressure-sensitive adhesive layer which contains at least an acrylic polymer formed of a component including, as an essential monomer component, an alkyl (meth)acrylate having an alkyl group having 9 or less carbon atoms (which may be referred to as a “C₁₋₉ alkyl (meth)acrylate”).

In this description, the pressure-sensitive adhesive layer which contains at least an acrylic polymer formed of a component including, as an essential monomer component, C₁₋₉ alkyl (meth)acrylate may be referred to as “the pressure-sensitive adhesive layer of the present invention”.

“(Meth)acryl” means “acryl” and/or “methacryl” (one or both of “acryl” and “methacryl”), and the same shall apply hereinunder. In addition, the “alkyl group” means a linear or branched alkyl group, if not otherwise specified.

In this description, the “pressure-sensitive adhesive sheet” is meant to include a “pressure-sensitive adhesive tape”. Specifically, the double-sided pressure-sensitive adhesive sheet of the present invention may also be a double-sided pressure-sensitive adhesive tape in a tape shape.

(Pressure-Sensitive Adhesive Layer in the Present Invention)

The pressure-sensitive adhesive layer of the present invention (essential pressure-sensitive adhesive layer of the double-sided pressure-sensitive adhesive sheet of the present invention) contains at least an acrylic polymer formed of a component including, as an essential monomer component, C₁₋₉ alkyl (meth)acrylate.

The acrylic polymer is formed of a component including, as an essential monomer component, at least C₁₋₉ alkyl (meth)acrylate. That is, the acrylic polymer is formed of a monomer component containing at least C₁₋₉ alkyl (meth)acrylate.

The C₁₋₉ alkyl (meth)acrylate is not particularly limited, and examples thereof include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate (2EHA), isooctyl (meth)acrylate, nonyl (meth)acrylate, and isononyl (meth)acrylate. Among them, alkyl (meth)acrylate having an alkyl group having 4 to 9 carbon atoms is preferable, and 2-ethylhexyl (meth)acrylate is more preferable, and 2-ethylhexyl acrylate is further more preferable, from the viewpoint of the adhesiveness when it is used at room temperature. The C₁₋₉ alkyl (meth)acrylate may be used either alone or in combination of two or more thereof.

The monomer component constituting the acrylic polymer may contain alkyl (meth)acrylate having an alkyl group having 10 to 24 carbon atoms (which may be referred to as “C₁₀₋₂₄ alkyl (meth)acrylate”). The C₁₀₋₂₄ alkyl (meth)acrylate is not particularly limited, and examples thereof include decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, isopentadecyl (meth)acrylate, hexadecyl (meth)acrylate, isohexadecyl (meth)acrylate, heptadecyl (meth)acrylate, isoheptadecyl (meth)acrylate, octadecyl (meth)acrylate, isooctadecyl (meth)acrylate, docosadecyl (meth)acrylate, isodocosadecyl (meth)acrylate, tetracosadecyl (meth)acrylate, and isotetracosadecyl (meth)acrylate. Among them, decyl (meth)acrylate, isodecyl (meth)acrylate, and dodecyl (meth)acrylate are preferable, from a viewpoint of balance of the adhesiveness. The C₁₀₋₂₄ alkyl (meth)acrylate may be used either alone or in combination of two or more thereof.

The above monomer components may further include a polar group-containing monomer. When the polar group-containing monomer is included in the monomer components, since the polar group-containing monomer has a moderate polarity, the pressure-sensitive adhesive layer can exhibit a moderate pressure-sensitive adhesive force. The polar group-containing monomer is a monomer having a polar group in its molecules (especially, ethylenically unsaturated monomer).

The polar group-containing monomer is not particularly limited, and examples thereof include a hydroxyl group-containing monomer such as hydroxyl alkyl (meth)acrylate, e.g. 2-hydroxyethyl (meth)acrylate (HEA), 3-hydroxypropyl (meth)acrylate, 4-hydroxybutyl (meth)acrylate, 6-hydroxyhexyl (meth)acrylate and the like, vinyl alcohol and allyl alcohol; an amide group-containing monomer such as (meth)acrylamide, N,N-dimethyl (meth)acrylamide (DMAA), N,N-diethyl (meth)acrylamide (DEAA), N-methylol (meth)acrylamide, N-methoxymethyl (meth)acrylamide, N-butoxymethyl (meth)acrylamide, and N-hydroxyethyl (meth)acrylamide; an amino group-containing monomer such as aminoethyl (meth)acrylate, dimethylaminoethyl (meth)acrylate and t-butylaminoethyl (meth)acrylate; a carboxyl group-containing monomer such as acrylic acid (AA), methacrylic acid, itaconic acid, maleic acid, fumaric acid and crotonic acid; acid anhydride of the carboxyl group-containing monomer (for example, acid anhydride group-containing monomer such as maleic anhydride and itaconic anhydride), an epoxy group-containing monomer such as glycidyl (meth)acrylate and methyl glycidyl (meth)acrylate; a cyano group-containing monomer such as acrylonitrile and methacrylonitrile; a hetero ring-containing vinyl monomer such as N-vinyl-2-pyrrolidone (NVP), N-vinyl-caprolactam, (meth)acryloylmorpholine, N-vinylpyridine, N-vinylpiperidone, N-vinylpyrimidine, N-vinylpiperazine, N-vinylpyrrole, N-vinylimidazole, N-vinyloxazole and (meth)acryloylmorpholine (ACMO); a sulfonate group-containing monomer such as sodium vinylsulfonate; a phosphate group-containing monomer such as 2-hydroxyethylacryloyl phosphate; an imide group-containing monomer such as cyclohexylmaleimide and isopropylmaleimide; and an isocyanate group-containing monomer such as 2-methacryloyloxyethyl isocyanate. The polar group-containing monomer may be used alone or in combination of two or more thereof.

The polar group-containing monomer is not particularly limited, but from the standpoint of capable of exhibiting the good adhesion property, the polar group-containing monomer is preferably at least one monomer selected from the group consisting of a hydroxyl group-containing monomer, nitrogen atom-containing monomer and carboxyl group-containing monomer. Above all, from the standpoint of the moderate elastic modulus at room temperature and the increase of the elastic modulus at −50° C., the polar group-containing monomer is more preferably a combination of a hydroxyl group-containing monomer and a hetero ring-containing vinyl monomer (especially, a hetero ring-containing monomer having a nitrogen atom), a nitrogen atom-containing monomer (especially, an amide group-containing monomer or a hetero ring-containing monomer having a nitrogen atom), or a carboxyl group-containing monomer, and is further more preferably a combination of a hydroxyl group-containing monomer and a hetero ring-containing vinyl monomer (especially, a hetero ring-containing monomer having a nitrogen atom), or an amide group-containing monomer.

The nitrogen atom-containing monomer is a monomer including at least one nitrogen atom in its molecules. As the nitrogen atom-containing monomer, examples thereof include the amide group-containing monomer and a hetero ring-containing vinyl monomer having a nitrogen atom. Above all, preferable examples thereof include N-vinyl-2-pyrrolidone (NVP), N-vinyl-caprolactam, N,N-dimethyl acrylamide (DMAA), N,N-diethyl (meth)acrylamide (DEAA) and the like. The hydroxyl group-containing monomer is not particularly limited, but is preferably 2-hydroxylethyl acrylate.

The monomer components may further include an alicyclic monomer. The alicylic monomer is an alicylic compound excluding an aromatic compound, and is a monomer including a nonaromatic ring in its molecules. The nonaromatic ring is not particularly limited, and examples thereof include a non-aromatic alicyclic ring (e.g., cycloalkane ring such as cyclopentane ring, cyclohexane ring, cycloheptane ring and cyclooctane ring; cycloalkene ring such as cyclohexene ring), a non-aromatic crosslinked ring (e.g., crosslinked hydrocarbon ring, for example, bicyclic hydrocarbon ring such as pinane, pinene, bornane, norbornane and norbornene; tricyclic hydrocarbon ring such as adamantane; tetracyclic hydrocarbon ring), etc.

The alicyclic monomer is not particularly limited, and examples thereof include, for example, a cycloalkyl (meth)acrylate such as cyclopentyl (meth)acrylate, cyclohexyl (meth)acrylate, cycloheptyl (meth)acrylate and cyclooctyl (meth)acrylate; a (meth)acrylic acid ester having a bicyclic hydrocarbon ring such as bornyl (meth)acrylate and isobornyl (meth)acrylate (IBXA or IBXMA); a (meth)acrylic acid ester having a tricyclic or more multicyclic hydrocarbon ring such as dicyclopentanyl (meth)acrylate, dicyclopentanyloxyethyl (meth)acrylate, tricyclopentanyl (meth)acrylate, 1-adamantyl (meth)acrylate, 2-methyl-2-adamantyl (meth)acrylate and 2-ethyl-2-adamantyl (meth)acrylate. The alicylic monomer is not particular limited, and preferable examples thereof include cyclohexyl acrylate (CHA), cyclohexyl methacrylate (CHMA), isobornyl acrylate (IBXA) and isobornyl methacrylate (IBXMA). Above all, from the standpoint of the improvement of the adhesion reliability at a high temperature, the monomer components preferably include both of the alicylic monomer and the nitrogen atom-containing monomer (especially, amide group-containing monomer). The alicyclic monomers may be used alone or in combination of two or more thereof.

The monomer component may further include a polyfunctional monomer. The polyfunctional monomer is not particularly limited, and examples thereof include hexanediol di(meth)acrylate (such as 1,6-hexanediol di(meth)acrylate), butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxyacrylate, polyester acrylate and urethane acrylate. Above all, 1,6-hexanediol diacrylate (HDDA) and dipentaerythritol hexaacrylate (DPHA) are preferable. The polyfunctional monomer may be used alone or in combination of two or more thereof.

As the monomer component, any monomer (other monomer) other than the C₁₋₉ alkyl (meth)acrylate, the C₁₀₋₂₄ alkyl (meth)acrylate, the polar group-containing monomer, the alicyclic monomer, and the polyfunctional monomer may be used. As the other monomer, examples thereof include (meth)acrylic acid ester having an aromatic hydrocarbon group such as phenyl (meth)acrylate, phenoxyethyl (meth)acrylate and benzyl (meth)acrylate. In addition, examples thereof further include vinyl esters such as vinyl acetate and vinyl propionate; aromatic vinyl compounds such as styrene and vinyltoluene; olefins or dienes such as ethylene, butadiene, isoprene and isobutylene; vinyl ethers such as vinyl alkyl ether; vinyl chloride, etc. These other monomers may be used either alone or in combination of two or more kinds thereof.

The content of the C₁₋₉ alkyl (meth)acrylate in the monomer component is not particularly limited, and is preferably from 50 to 99 wt %, more preferably from 55 to 95 wt %, and even more preferably from 60 to 90 wt %, based on the total amount (100 wt %) of the monomer component. When the content thereof is 50 wt % or more, moderate flexibility can be secured. When the content thereof is 99 wt % or less, other monomers can be combined and further improved adhesive property can be realized.

Among them, from the viewpoint of further easily securing the flexibility of the tape, based on the total amount (100 wt %) of the monomer component, it is preferable to contain 40 to 95 wt % of 2-ethylhexyl (meth)acrylate and more preferable to contain 60 to 90 wt % of 2-ethylhexyl (meth)acrylate.

In the case of containing the C₁₀₋₂₄ alkyl (meth)acrylate in the monomer component, the content thereof is not particularly limited, and is preferably from 2 to 70 wt %, more preferably 3 to 40 wt %, and even more preferably 3 to 30 wt %, based on the total amount (100 wt %) of the monomer component. When the content thereof is 2 wt % or more, viscoelasticity can be suitably adjusted. When the content thereof is 70 wt % or less, the decrease of the flexibility can be suppressed.

In the case of containing the polar group-containing monomer in the monomer component, the content thereof is not particularly limited, and is preferably from 5 to 51 wt %, more preferably from 5 to 50 wt %, more preferably 8 to 40 wt %, and even more preferably 8 to 35 wt %, based on the total amount (100 wt %) of the monomer component. When the content thereof is 5 wt % or more, moderate polarity of the pressure-sensitive adhesive can be acquired. When the content thereof is 50 wt % or less, the increase of the elastic modulus (excessive increase of shear storage elastic modulus at 23° C.) can be suppressed.

Among them, in the case of containing both a hydroxyl group-containing monomer and a nitrogen atom-containing monomer in the monomer component, the content thereof is not particularly limited, and for example, based on the total amount (100 wt %) of the monomer component, the content of the hydroxyl group-containing monomer is preferably from 1 to 30 wt % (more preferably from 5 to 20 wt % and even more preferably from 10 to 20 wt %), and the content of the nitrogen atom-containing monomer is preferably from 1 to 50 wt % (more preferably from 10 to 40 wt % and even more preferably from 10 to 35 wt %). When the content of each of the hydroxyl group-containing monomer and the nitrogen atom-containing monomer is in the range described above, excellent balance of adhesive property can be acquired.

In the case of containing the alicyclic monomer in the monomer component, the content thereof is not particularly limited, and for example, the content thereof is preferably from 1 to 40 wt %, more preferably from 3 to 30 wt %, and even more preferably from 5 to 25 wt %, based on the total amount (100 wt %) of the monomer component. When the content thereof is 1 wt % or more, it is possible to adjust the shear storage elastic modulus at 23° C. and −50° C. to a suitable range, respectively. When the content thereof is 40 wt % or less, the loss of tackiness due to the increase of the elastic modulus (excessive increase of shear storage elastic modulus at 23° C.) can be suppressed.

In the case of containing both the polar group-containing monomer (particularly, the nitrogen atom-containing monomer such as an amide group-containing monomer) and the alicyclic monomer in the monomer component, the total content (total content of the polar group-containing monomer and the alicyclic monomer) is not particularly limited, and for example, the content thereof is preferably from 10 to 50 wt %, more preferably from 15 to 40 wt %, and even more preferably from 20 to 30 wt %, based on the total amount (100 wt %) of the monomer component. When the content thereof is 10 wt % or more, the excellent balance of the adhesive property can be acquired. When the content thereof is 50 wt % or less, the loss of the tackiness due to the increase of the elastic modulus can be prevented.

In the case of containing the polyfunctional monomer in the monomer component, the content thereof is not particularly limited, and for example, the content thereof is preferably from 0.001 to 5 wt %, more preferably from 0.01 to 1 wt %, and even more preferably from 0.01 to 0.5 wt %, based on the total amount (100 wt %) of the monomer component. When the content thereof is 0.001 wt % or more, adhesion reliability at a high temperature can be acquired. When the content thereof is 5 wt % or less, the tackiness can be realized.

Among them, from the viewpoints of more excellent pressure-sensitive adhesive property at room temperature and more excellent reworkability at a low temperature (for example, −50° C. to −30° C.), as the monomer component constituting the acrylic polymer, the following monomer components are preferable: a monomer component which contains the C₁₋₉ alkyl (meth)acrylate, the nitrogen atom-containing monomer, and the alicyclic monomer, in which, based on the total amount (100 wt %) of the monomer component, the content of the C₁₋₉ alkyl (meth)acrylate is from 65 to 70 wt %, the content of the nitrogen atom-containing monomer is from 17 to 22 wt %, and the content of the alicyclic monomer is from 8 to 13 wt %; a monomer component which contains the C₁₋₉ alkyl (meth)acrylate, the hydroxyl group-containing monomer, and the nitrogen atom-containing monomer, in which, based on the total amount (100 wt %) of the monomer component, the content of the C₁₋₉ alkyl (meth)acrylate is from 65 to 70 wt %, the content of the hydroxyl group-containing monomer is from 15 to 20 wt %, and the content of the nitrogen atom-containing monomer is from 10 to 15 wt %; a monomer component which contains the C₁₋₉ alkyl (meth)acrylate and the carboxyl group-containing monomer, in which, based on the total amount (100 wt %) of the monomer component, the content of the C₁₋₉ alkyl (meth)acrylate is from 87 to 92 wt % and the content of the carboxyl group-containing monomer is from 8 to 13 wt %; and a monomer component which contains the C₁₋₉ alkyl (meth)acrylate and the nitrogen atom-containing monomer (particularly, the amide-group containing monomer or a hetero ring-containing vinyl monomer containing a nitrogen atom), in which, based on the total amount (100 wt %) of the monomer component, the content of the C₁₋₉ alkyl (meth)acrylate is from 70 to 80 wt % and the content of the nitrogen atom-containing monomer is from 20 to 30 wt %.

That is to say, the acrylic polymer contains at least a structural unit derived from the C₁₋₉ alkyl (meth)acrylate. The acrylic polymer obtained by polymerization of the monomer component may contain a structural unit derived from the C₁₀₋₂₄ alkyl (meth)acrylate, a structural unit derived from the polar group-containing monomer, a structural unit derived from the alicyclic monomer, a structural unit derived from the polyfunctional monomer, and a structural unit derived from the other monomer. Each structural unit may be one kind, or two or more kinds.

The acrylic polymer can be prepared through polymerization of the monomer components by any general polymerization method. Examples of the polymerization method of the monomer components include, for example, a solution polymerization method, an emulsion polymerization method, a bulk polymerization method, a polymerization method by heat or active energy-ray irradiation (thermal polymerization method, active energy-ray polymerization method) and the like. From the viewpoint of the transparency, water resistance and the cost, a solution polymerization method and an active energy-ray polymerization method are preferred. The monomer components and a partially polymerized product of the monomer components are not particularly limited, but it is preferred that the polymerization is conducted so as to avoid the contact with oxygen (e.g. under a nitrogen atmosphere).

As the active energy-ray irradiated in the active energy-ray polymerization (photopolymerization), examples thereof include an ionizing radiation such as an alpha ray, a beta ray, a gamma ray, a neutron ray and an electron ray, or UV, and UV is preferable. An irradiation energy, irradiation time and irradiation method of the active energy-ray are not particularly limited so long as the monomer components may be reacted by activating a photopolymerization initiator.

In the solution polymerization, various kinds of general solvents can be used. Examples of such a solvent include organic solvents such as: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used either alone or in combination of two or more kinds thereof.

When the monomer components are polymerized, a polymerization initiator such as a photopolymerization initiator (photoinitiator) and a thermal polymerization initiator may be used depending on the kind of polymerization reaction. The polymerization initiator may be used alone or in combination of two or more kinds thereof.

The photopolymerization initiator is not particularly limited, and examples thereof include, for example, a benzoin ether photopolymerization initiator, an acetophenon photopolymerization initiator, an α-ketol photopolymerization initiator, an aromatic sulfonyl chloride photopolymerization initiator, a photoactive oxime photopolymerization initiator, a benzoin photopolymerization initiator, a benzyl photopolymerization initiator, a benzophenon photopolymerization initiator, a ketal photopolymerization initiator and a thioxantone photopolymerization initiator. The content of the photopolymerization initiator used is not particularly limited, but is preferably 0.01 to 1 wt %, and more preferably 0.05 to 0.5 wt % based on the total amount (100 wt %) of the monomer components to form the acrylic polymer.

As the benzoin ether photopolymerization initiator, examples thereof include benzoin methyl ether, benzoin ethyl ether, benzoin propyl ether, benzoin isopropyl ether, benzoin isobutyl ether, 2,2-dimethoxy-1,2-diphenylethane-1-on and anisole methyl ether. As the acetophenon photopolymerization initiator, examples thereof include 2,2-diethoxyacetophenon, 2,2-dimethoxy-2-phenylacetophenon, 1-hydroxycyclohexylphenylketone, 4-phenoxydichloroacetophenon and 4-(t-butyl)dichloroacetophenon. As the α-ketol photopolymerization initiator, examples thereof include 2-methyl-2-hydroxypropiophenon and 1-[4-(2-hydroxyethyl)phenyl]-2-methylpropane-1-on. As the aromatic sulfonyl chloride photopolymerization initiator, examples thereof include 2-naphthalenesulfonyl chloride. As the photoactive oxime photopolymerization initiator, examples thereof include 1-phenyl-1,1-propanedion-2-(o-ethoxycarbonyl)-oxime. As the benzoine photopolymerization initiator, examples thereof include benzoin. As the benzyl photopolymerization initiator, examples thereof include benzyl. As the benzophenon photopolymerization initiator, examples thereof include benzophenon, benzoylbenzoate, 3,3′-dimethyl-4-methoxybenzophenon, polyvinylbenzophenon and α-hydroxycyclohexyl phenyl ketone. As the ketal photopolymerization initiator, examples thereof include benzyl dimethyl ketal. As the thioxantone photopolymerization initiator, examples thereof include thioxantone, 2-chlorothioxantone, 2-methylthioxantone, 2,4-dimethylthioxantone, isopropylthioxantone, 2,4-diisopropylthioxantone and dodecylthioxantone.

As the thermal polymerization initiator, examples thereof include an azo polymerization initiator, a peroxide polymerization initiator (for example, dibenzoyl peroxide and tert-butyl permaleate) and a redox polymerization initiator. Above all, the azo polymerization initiator disclosed in JP-A-2002-69411 is preferable. As the azo polymerization initiator, examples thereof include 2,2′-azobisisobutyronitrile, 2,2′-azobis-2-methylbutyronitrile, dimethyl 2,2′-azobis(2-methylpropionate) and 4,4′-azobis-4-cyanovaleric acid. The content of the thermal polymerization initiator used is preferably 0.05 to 0.5 wt %, and more preferably 0.1 to 0.3 wt % based on the total amount (100 wt %) of the monomer component to form the acrylic polymer.

The acrylic polymer may be a fully-polymerized product of the monomer component or may be a partially polymerized product. A rate of polymerization of the acrylic polymer is not particularly limited, and for example, is preferably from 5 to 20 wt % and more preferably from 5 to 15 wt %, from the viewpoint of handling or a coating property.

The rate of the polymerization is acquired as follows.

A specimen is prepared by sampling a part of the acrylic polymer. The weight of the specimen is acquired by precise weighing thereof, and is set as a “weight of the partially polymerized product before drying”. Next, the specimen is dried at 130° C. for 6 hours, and the weight of the specimen after drying is acquired by precise weighing thereof, and is set as a “weight of the partially polymerized product after drying”. From the “weight of the partially polymerized product before drying” and the “weight of the partially polymerized product after drying”, the weight of the specimen which is reduced by drying at 130° C. for 2 hours is acquired, and is set as a “weight-reduced amount” (volatile matter, non-reactive monomer weight). From the obtained “weight of the partially polymerized product before drying” and the “weight-reduced amount”, the rate of polymerization (wt %) of the partially polymerized product of the monomer component is acquired by the following Equation.

Rate (wt %) of partially polymerized product of monomer component=[1−(weight-reduced amount)/(weight of partially polymerized product before drying)]×100

The acrylic polymer contained in the pressure-sensitive adhesive layer may be only the acrylic polymer formed of the component including, as the essential monomer component, the C₁₋₉ alkyl (meth)acrylate, or may contain an acrylic polymer formed of the component including, as the essential monomer component, the C₁₋₉ alkyl (meth)acrylate, and the acrylic polymer other than the acrylic polymer formed of the component including, as the essential monomer component, the C₁₋₉ alkyl (meth)acrylate.

The content of the acrylic polymer in the pressure-sensitive adhesive layer is not particularly limited, and for example, is preferably 30 wt % or more, more preferably 50 wt % or more, and even more preferably 70 wt % or more, based on total amount (total weight, 100 wt %) of the pressure-sensitive adhesive layer, from the viewpoint of the adhesive property.

The pressure-sensitive adhesive sheet may further include a crosslinking agent. The crosslinking agent is not particularly limited, and examples thereof include an isocyanate-based crosslinking agent, an epoxy-based crosslinking agent, a melamine-based crosslinking agent, a peroxide-based crosslinking agent, an urea-based crosslinking agent, a metal alkoxide-based crosslinking agent, a metal chelate-based crosslinking agent, a metal salt-based crosslinking agent, a carbodiimide-based crosslinking agent, an oxazoline-based crosslinking agent, an aziridine-based crosslinking agent, an amine-based crosslinking agent and the like. Among them, the isocyanate-based crosslinking agent and the epoxy-based crosslinking agent are preferable. The crosslinking agent may be used either alone or in combination of two or more kinds thereof.

As the isocyanate-based crosslinking agent (polyfunctional isocyanate compound), examples thereof include lower aliphatic polyisocyanates such as 1,2-ethylene diisocyanate, 1,4-butylenediisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylylene diisocyanate. Other than the above, a trimethylolpropane/tolylene diisocyanate adduct (e.g. trade name “CORONATE L”, manufactured by Nippon Polyurethane Industry Co., Ltd.), and a trimethylolpropane/hexamethylene diisocyanate adduct (e.g. trade name “CORONATE HL”, manufactured by Nippon Polyurethane Industry Co., Ltd.) may also be used.

As the epoxy-based crosslinking agent (polyfunctional epoxy compound), examples thereof include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylolpropane polyglycidyl ether, adipic acid diglycidyl ester, o-phthalic diglycidyl ester, triglycidyl-tris(2-hydroxyethyl)isocyanurate, resorcin diglycidyl ether, bisphenol-S-diglycidyl ether and an epoxy-based resin having two or more epoxy groups in the molecule. As commercially available products, trade name “TETRAD C” manufactured by Mitsubishi Gas Chemical Company, Inc. may be used.

The content of the crosslinking agent in the pressure-sensitive adhesive layer is not particularly limited, but is, for example, preferably from 0.001 to 10 wt %, more preferably from 0.01 to 3 wt % based on the total amount (100 wt %) of the monomer components to form the acrylic polymer, from the viewpoint of controlling the gel fraction of the pressure-sensitive adhesive layer to fall within the preferred range thereof.

The pressure-sensitive adhesive layer may further contain a silane coupling agent. The silane coupling agent is not particularly limited, and for example, a silane coupling agent having a functional group (for example, a vinyl group, an epoxy group, an amino group, a mercapto group, an acryloxy group, a methacryloxy group, an isocyanate group, a styryl group, a polysulfide group or the like) can be used. Specific examples thereof include a vinyl group-containing silane coupling agent such as vinyl trimethoxysilane; an epoxy group-containing silane coupling agent such as γ-glycidoxypropyl trimethoxysilane, or γ-glycidoxypropyl triethoxysilane; an amino group-containing silane coupling agent such as γ-aminopropyl trimethoxysilane or N-β(aminoethyl) γ-aminopropyl trimethoxysilane; a mercapto group-containing silane coupling agent such as γ-mercaptopropyl methyldimethoxysilane; an acryloxy group-containing silane coupling agent such as γ-acryloxypropyl trimethoxysilane; a methacryloxy group-containing silane coupling agent such as γ-methacryloxypropyl triethoxysilane; an isocyanate group-containing silane coupling agent such as 3-isocyanatepropyl triethoxysilane; a styryl group-containing silane coupling agent such as p-styryl trimethoxysilane; and a polysulfide group-containing silane coupling such as bis(triethoxysilylpropyl) tetrasulfide. Among them, the silane coupling agent having an epoxy group (the epoxy group-containing silane coupling agent) is preferable from the viewpoint of the adhesive property to glasses or resin surfaces. The silane coupling agent can be used alone or in combination of two or more kinds thereof.

The content of the silane coupling agent is not particularly limited, and for example, is preferably from 0.01 to 20 wt % and more preferably from 0.03 to 1 wt %, based on the total amount (100 wt %) of the monomer component constituting the acrylic polymer.

In the pressure-sensitive adhesive, if necessary, additives (other additives) such as a crosslinking accelerator, a tackifying resin (rosin derivative, polyterpene resin, petroleum resin, and oil-soluble phenol), an antiaging agent, a filler, a colorant (dye or pigment), a UV absorbing agent, an antioxidant, a chain-transfer agent, a plasticizer, a softener, a surfactant and an antistatic agent may be included.

The pressure-sensitive adhesive layer of the present invention is not particularly limited, and, for example, is formed from a pressure-sensitive adhesive composition. The pressure-sensitive adhesive composition which can form the pressure-sensitive adhesive layer of the present invention may be a pressure-sensitive adhesive composition having any forms. For example, a solvent-type pressure-sensitive adhesive composition or an active energy-ray-curable pressure-sensitive adhesive composition may be used.

The solvent-type pressure-sensitive adhesive composition is not particularly limited, and for example, it can be prepared by dissolving the acrylic polymer, the crosslinking agent, the silane coupling agent, and the other additives in a solvent.

The solvent used when the solvent-type pressure-sensitive adhesive composition is prepared is not particularly limited, and examples of such a solvent include organic solvents such as: esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; ketones such as methylethylketone and methylisobutylketone; and alcohols such as methanol and butanol. The solvents may be used either alone or in combination of two or more kinds thereof.

The active energy-ray-curable pressure-sensitive adhesive composition is not particularly limited, and for example, it can be prepared by mixing the monomer components and/or the partially polymerized product of the monomer components, the polymerization initiator, the crosslinking agent, the silane coupling agent, and the other additives. The “partially polymerized product of the monomer components” means a component where one or more of the components of the monomer components have been partially polymerized. That is, examples thereof include a mixture of the monomer component and the partially polymerized product of the monomer component.

Among them, the active energy-ray-curable pressure-sensitive adhesive composition is preferable for the pressure-sensitive adhesive composition which can form the pressure-sensitive adhesive layer of the present invention, from the viewpoints of productivity, influences on the environment, and obtaining a thick pressure-sensitive adhesive layer.

The thickness of the pressure-sensitive adhesive layer of the present invention is not particularly limited, and is preferably from 10 μm to 1 mm, more preferably from 100 to 500 μm, and even more preferably from 150 to 350 μm, from the viewpoints of processability and step absorbability. When the thickness of the pressure-sensitive adhesive layer is 10 μm or more, the step absorbability is improved. When the thickness of the pressure-sensitive adhesive layer is 1 mm or less, deformation of the pressure-sensitive adhesive layer hardly occurs and the processability is improved.

The shear storage elastic modulus at 23° C. (which may be referred to as a “shear storage elastic modulus (23° C.)”) of the pressure-sensitive adhesive layer of the present invention, which is measured by dynamic viscoelasticity measurement, is 5.0×10⁵ Pa or less (for example, from 1.0×10⁴ to 5.0×10⁵ Pa), preferably 4.0×10⁵ Pa or less (for example, from 1.0×10⁴ to 4.0×10⁵ Pa), and more preferably 3.0×10⁵ Pa or less (for example, from 1.0×10⁴ to 3.0×10⁵ Pa). When the shear storage elastic modulus (23° C.) of the pressure-sensitive adhesive layer in the invention is 5.0×10⁵ Pa or less, excellent adhesive property at room temperature (23° C.) is obtained.

The shear storage elastic modulus at −50° C. (which may be referred to as a “shear storage elastic modulus (−50° C.)”) of the pressure-sensitive adhesive layer in the invention, which is measured by dynamic viscoelasticity measurement, is 1.0×10⁸ Pa or more (for example, from 1.0×10⁸ to 1.0×10¹⁰ Pa), preferably 2.0×10⁸ Pa or more (for example, from 2.0×10⁸ to 5.0×10⁹ Pa), and more preferably 3.0×10⁸ Pa or more (for example, from 3.0×10⁸ to 1.0×10⁹ Pa). When the shear storage elastic modulus (−50° C.) of the pressure-sensitive adhesive layer in the invention is 1.0×10⁸ Pa or more, since the pressure-sensitive adhesive layer is cohered and hardened, adherends attached to the pressure-sensitive adhesive layer of the present invention is easily peeled at −50° C.

In addition, the shear storage elastic modulus at −30° C. (which may be referred to as a “shear storage elastic modulus (−30° C.)”) of the pressure-sensitive adhesive layer in the invention, which is measured by dynamic viscoelasticity measurement, is not particularly limited, and is for example, 1.0×10⁶ Pa or more (for example, from 1.0×10⁶ to 1.0×10¹⁰ Pa), preferably 5.0×10⁶ Pa or more (for example, from 5.0×10⁶ to 5.0×10⁹ Pa), and more preferably 1.0×10⁷ Pa or more (for example, from 1.0×10⁷ to 1.0×10⁹ Pa).

The shear storage elastic modulus is a value measured by the following “Method of dynamic viscoelasticity measurement”.

### (Method of Dynamic Viscoelasticity Measurement)

A plurality of pressure-sensitive adhesive layers are laminated to prepare a laminate of the pressure-sensitive adhesive layers, the laminate having a thickness of about 2 mm, and the laminate is set as a test piece. The test piece is measured by a shear mode at a temperature-rising rate of 5° C./min in the temperature range of −70° C. to 200° C. under the condition of a frequency of 1 Hz by using a “Advanced Rheometric Expansion System (ARES)” manufactured by Rheomatric Scientific, Inc., and the shear storage elastic modulus at −50° C., the shear storage elastic modulus at −30° C., and the shear storage elastic modulus at 23° C. are calculated.

The gel fraction of the pressure-sensitive adhesive layer of the present invention is not particularly limited, and for example, is preferably from 20 to 90 wt %, more preferably from 30 to 85 wt %, and even more preferably from 40 to 80 wt %. When the gel fraction is 90 wt % or less, then the cohesive force of the pressure-sensitive adhesive layer could lower in some degree so that the pressure-sensitive adhesive layer can be flexible, the pressure-sensitive adhesive layer can readily follow a step, and the step absorbability thereof is therefore improved. On the other hand, when the gel fraction is less than 20 wt %, then the pressure-sensitive adhesive layer is too flexible so that the processability of the double-sided pressure-sensitive adhesive sheet is worsened. In addition, in high-temperature environments or in high-temperature and high-humidity environments, a problem of bubbling or lifting may be easily occurred, and the anti-foaming release property of the pressure-sensitive adhesive sheet is thereby worsened. The gel fraction can be controlled by suitably selecting and controlling the kind and the content (amount to be used) of the polyfunctional monomer and/or the crosslinking agent.

The gel fraction (ratio of the solvent-insoluble content) is determined in terms of the ethyl acetate-insoluble content. Concretely, the pressure-sensitive adhesive layer is immersed in ethyl acetate at room temperature (23° C.) for 7 days, and then the weight fraction (unit: wt %) of the insoluble matter in the immersed sample relative to that of the insoluble matter in the sample before immersion is calculated, and this indicates the gel fraction. More concretely, the gel fraction is a value calculated by the following “Method of measuring gel fraction”.

### (Method of Measuring Gel Fraction)

About 1 g of the pressure-sensitive adhesive layer is sampled, and the weight thereof is measured, and the weight measured is designated as the “weight of the pressure-sensitive adhesive layer before immersion”. Then, the sampled pressure-sensitive adhesive layer is immersed in 40 g of ethyl acetate for 7 days, and then, all components not soluble (insoluble components) in ethyl acetate are collected, the collected insoluble components are dried at 130° C. for 2 hours to remove ethyl acetate, and the weight thereof is measured, and this weight is designated as the “dry weight of the insoluble components” (the weight of the pressure-sensitive adhesive layer after immersion). The obtained numerical values are substituted in the following equation for calculation.

Gel fraction (wt %)=[(dry weight of the insoluble components)/(weight of the pressure-sensitive adhesive layer before immersion)]×100

The weight-average molecular weight of the soluble components (sol matter) of the pressure-sensitive adhesive layer of the present invention is not particularly limited, and is preferably from 1.0×10⁵ to 5.0×10⁶, more preferably from 2.0×10⁵ to 2.0×10⁶, and even more preferably from 3.0×10⁵ to 1.0×10⁶. When the weight-average molecular weight of the sol matter is 1.0×10⁵ or more, the pressure-sensitive adhesive force at room temperature (23° C.) is further improved. In addition, when the weight-average molecular weight of the sol matter is 5.0×10⁶ or less, the shear storage elastic modulus (23° C.) is prevented from being too high and the pressure-sensitive adhesive force at room temperature is further improved.

The above-mentioned “weight-average molecular weight of the soluble components (sol matter)” is calculated by the following measuring method.

### (Method of Measuring Weight-Average Molecular Weight of Soluble Components (Sol Matter))

Pressure-sensitive adhesive layer: about 1 g of the pressure-sensitive adhesive layer is sampled, wrapped with a porous tetrafluoroethylene sheet (trade name “NTF1122”, manufactured by Nitto Denko Corporation) having an average pore size of 0.2 μm, and it is tied up with a kite string (called a “sample”). Subsequently, the sample is put in a 50 ml-volume vessel filled with ethyl acetate, and is allowed to stand still at 23° C. for 1 week (7 days). The ethyl acetate solution (containing extracted sol matter) is then taken out of the vessel and dried under reduced pressure, and the solvent (ethyl acetate) is evaporated away to obtain sol matter.

The sol matter is dissolved in tetrahydrofuran (THF), followed by measuring under the following measurement conditions of GPC with polystyrene-converted value, by using trade name “HLC-8120GPC” manufactured by TOSHO CORPORATION as a GPC measuring device, to measure the weight-average molecular weight (Mw) of the sol matter.

### (Measurement Conditions of GPC)

Sample concentration: 0.2 wt % (tetrahydrofuran solution)

Sample injection amount: 10 μl

Eluent: tetrahydrofuran (THF)

Flow volume (flow rate): 0.6 mL/min

Column temperature (measurement temperature): 40° C.

Column: trade name “TSKgelSuper HM-H/H4000/H3000/H2000” (manufactured by TOSHO CORPORATION)

Detector: differential refractometer (RI)

Other than the pressure-sensitive adhesive layer of the present invention, the double-sided pressure-sensitive adhesive sheet of the present invention may include a substrate, a pressure-sensitive adhesive layer other than the pressure-sensitive adhesive layer of the present invention (which may be referred to as the “other pressure-sensitive adhesive layer”), and other layers (e.g., interlayer, undercoat layer) and the like, as long as the advantage of the present invention is not impaired.

The double-sided pressure-sensitive adhesive sheet of the present invention may be a double-sided pressure-sensitive adhesive sheet that does not have a substrate (substrate layer) (may be referred to as a “substrateless double-sided pressure-sensitive adhesive sheet”), or may be a double-sided pressure-sensitive adhesive sheet with a substrate (may be referred to as a “double-sided pressure-sensitive adhesive sheet with substrate”). The substrateless double-sided pressure-sensitive adhesive sheet is not particularly limited, and may be, for example, a double-sided pressure-sensitive adhesive sheet consisting of the pressure-sensitive adhesive layer of the present invention, a double-sided pressure-sensitive adhesive sheet composed of the pressure-sensitive adhesive layer of the present invention and a pressure-sensitive adhesive layer other than the pressure-sensitive adhesive layer of the present invention, or the like. The double-sided pressure-sensitive adhesive sheet with substrate is not particularly limited, and may be for example, a double-sided pressure-sensitive adhesive sheet including the pressure-sensitive adhesive layer of the present invention on both sides of the substrate, or a double-sided pressure-sensitive adhesive sheet including the pressure-sensitive adhesive layer of the present invention on one side of the substrate and the other pressure-sensitive adhesive layer on the other side of the substrate. Among them, for the double-sided pressure-sensitive adhesive sheet of the present invention, from the viewpoint of transparency or thick line-up, the substrateless double-sided pressure-sensitive adhesive sheet is preferable, and the substrateless double-sided pressure-sensitive adhesive sheet consisting of the pressure-sensitive adhesive layer of the present invention is more preferable.

### (Substrate)

The substrate is not particularly limited, and examples thereof include plastic films and various optical films such as anti-reflection (AR) film, polarizing plate and retardation film. Examples of a material of the plastic film include plastic materials, e.g. polyester resins such as polyethylene terephthalate (PET); acrylic resins such as polymethyl methacrylate; polycarbonate; triacetyl cellulose; polysulfone; polyarylate; polyimide; polyvinyl chloride; polyvinyl acetate; polyethylene; polypropylene; ethylene-propylene copolymer; and cyclic olefin polymer such as trade name “ARTON” (cyclic olefin polymer; manufactured by JSR), trade name “ZEONOR” (cyclic olefin polymer; manufactured by Nippon Zeon Co., Ltd.). The plastic materials may be used either alone or in combination of two or more kinds thereof.

The substrate is a part which is laminated to the adherend together with the pressure-sensitive adhesive layer when the double-sided pressure-sensitive adhesive sheet of the present invention is used for (laminated to) adherends (e.g., optical members). The separator (release liner) to be peeled off when the pressure-sensitive adhesive sheet of the present invention is used (laminated) is not included in the meaning of the substrate.

The substrate is not particularly limited, and is preferably a transparent substrate. As the “transparent substrate”, the total light transmittance in a visible light wavelength region of the substrate (in accordance with JIS K7361-1) is preferably 85% or more, and more preferably 88% or more. The haze of the transparent substrate (in accordance with JIS K7136) is preferably 1.5% or less, and more preferably 1.0% or less. The transparent substrate may be a PET film or a non-oriented film such as trade name “ARTON” (manufactured by JSR), and trade name “ZEONOR” (manufactured by Nippon Zeon Co., Ltd.).

The thickness of the substrate is not particularly limited, but for example, is preferably 12 μm to 75 μm. The substrate may have a single layer shape or multilayer shape. On the surface of the substrate, for example, a general surface treatment such as a physical treatment such as a corona discharge treatment and a plasma treatment, and a chemical treatment such as an undercoat treatment, may be properly performed.

### (Other Pressure-Sensitive Adhesive Layer)

The other pressure-sensitive adhesive layer (pressure-sensitive adhesive layer other than the pressure-sensitive adhesive layer of the present invention) is not particularly limited, and examples thereof include any general pressure-sensitive adhesive layers formed from any general pressure-sensitive adhesive, for example, an urethane-based pressure-sensitive adhesive, acrylic pressure-sensitive adhesive, rubber-based pressure-sensitive adhesive, silicone-based pressure-sensitive adhesive, polyester-based pressure-sensitive adhesive, polyamide-based pressure-sensitive adhesive, epoxy-based pressure-sensitive adhesive, vinyl alkyl ether-based pressure-sensitive adhesive, fluorine-based pressure-sensitive adhesive, etc. Those pressure-sensitive adhesives may be used either alone or in combination of two or more kinds thereof.

### (Separator)

The surface (pressure-sensitive adhesive surface) of the pressure-sensitive adhesive layer of the double-sided pressure-sensitive adhesive sheet of the present invention may be protected by a separator (release liner) until it is used. In the double-sided pressure-sensitive adhesive sheet of the present invention, each pressure-sensitive adhesive surface may be protected by two separators, respectively, or protected in such a way that the surface is wound in a roll form by using one separator of which both sides are release surfaces. The separator is used as a protective material of the pressure-sensitive adhesive layer, and is peeled when the double-sided pressure-sensitive adhesive sheet of the present invention is laminated to an adherend. In addition, the separator functions as a support of the pressure-sensitive adhesive layer.

Any general release paper may be used as the separator. The separator may be, but not particularly limited to, for example, a substrate having a release treated layer, a low adhesive substrate composed of a fluorine polymer, or a low adhesive substrate composed of a non-polar polymer. As the substrate having the release treated layer, examples thereof include a plastic film or paper whose surface is treated by a release agent such as silicon-based release agent, long-chain alkyl-based release agent, fluorine-based release agent, and molybdenum sulfide-based release agent. As the fluorine-based polymer, examples thereof include polytetrafluoroethylene, polychlorotrifluoroethylene, polyvinyl fluoride, polyvinylidene fluoride, a tetrafluoroethylene-hexafluoropropylene copolymer and a chlorofluoroethylene-vinylidene fluoride copolymer. As the non-polar polymer, examples thereof include an olefine-based resin (for example, polyethylene, polypropylene and the like). The separator can be formed by using a general method. The thickness of the separator is not particularly limited.

The thickness (total thickness) of the double-sided pressure-sensitive adhesive sheet of the present invention is not particularly limited, but is preferably from 10 μm to 1 mm, more preferably from 100 to 500 μm, and even more preferably from 150 to 350 μm. When the thickness thereof is 10 μm or more, the pressure-sensitive adhesive layer of the present invention can readily follow a step of the pressure-sensitive adhesive surface, and the step absorbability thereof is therefore improved. The thickness of the double-sided pressure-sensitive adhesive sheet of the present invention does not include the thickness of the separator.

The peel force of the double-sided pressure-sensitive adhesive sheet of the present invention in the following “Film T-type peel test” is not particularly limited, and is for example, preferably 3 N or less (for example, 0.01 to 3 N), more preferably 2.5 N or less (for example, 0.1 to 2.5 N), and even more preferably 2 N or less (for example, 0.2 to 2 N). When the peel force is 3 N or less, an adherend can be easily peeled off from the double-sided pressure-sensitive adhesive sheet at −50° C.

### <Film T-Type Peel Test>

One pressure-sensitive adhesive surface of the double-sided pressure-sensitive adhesive sheet (size of 50 mm length×20 mm width) and a surface of a polyethylene terephthalate film (PET film) (size of 150 mm length×20 mm width) are laminated, the other pressure-sensitive adhesive surface and a surface of a PET film (size of 150 mm length×20 mm width) are laminated, thereby preparing a test piece having a configuration of the PET film/the double-sided pressure-sensitive adhesive sheet/the PET film. Next, the test piece is put into an autoclave, and the test piece is treated under the condition of a temperature of 50° C. and a pressure of 5 atm for 15 minutes, and then, the test piece is allowed to stand for 30 minutes under the environment of a temperature at −50° C. The test piece is subject to the T-type peel test under the following conditions, to measure the peel force (N). More concretely, a test performed by the method disclosed in “(2) Film T-type peel test” in (Evaluation) described below is used.

Device: trade name “AUTOCLAVE” manufactured by Shimadzu Corporation

Sample width: 20 mm

Tensile speed: 300 mm/min

Temperature: −50° C.

Tensile direction: CD direction (a direction perpendicular to a longitudinal (MD) direction)

Number of repeating: n=3

The peel force is maximum load when the peel force is measured over a length of 50 mm of the test piece (maximum load when two PET films of the test piece having a length of 50 mm are peeled off) by the above <Film T-type peel test>.

The double-sided pressure-sensitive adhesive sheet of the present invention is not particularly limited, and for example, is preferably used in the method disclosed in the following “(3) Method of peeling plate”.

The double-sided pressure-sensitive adhesive sheet of the present invention is excellent in pressure-sensitive adhesive property at room temperature (23° C.) and has reworkability at a low temperature (for example, from −50 to −30° C.). The double-sided pressure-sensitive adhesive sheet of the present invention can be preferably used as a pressure-sensitive adhesive sheet (removable pressure-sensitive adhesive sheet) capable of being removed and allowing the separated adherends to be reused even in the case where it is used for laminating adherends together and the adherends are separated (removed).

The adherend is not particularly limited, and examples thereof include an optical member. As the optical member, a member having an optical characteristic (for example, a polarized property, a photorefractive property, a light scattering property, a light reflective property, a light transmitting property, a light absorbing property, a light diffractive property, an optical rotation property and visibility) can be used. The optical member is not particularly limited so long as the optical member is a member having the optical characteristic, and a member constituting an optical product such as display device (image display device) and input device, or a member used in the device (optical product) are exemplified, and examples thereof include a polarizing plate, a wave plate, a retardation plate, an optical compensation film, a brightness enhancing film, a light guide plate, a reflective film, an anti-reflective film, a transparent conductive film (e.g. ITO film), a design film, a decoration film, a surface protective film, a prism, lens, a color filter, a transparent substrate, and a member in which these are laminated.

The optical member is not particularly limited, and examples thereof include a member (for example, a sheet shape, film shape or plate shape of member) composed of plastic materials such as polyester resins such as polyethylene terephthalate (PET), acrylic resins such as polymethyl methacrylate, polycarbonate; triacetyl cellulose, polysulfone, polyarylate, polyimide, polyvinyl chloride, polyvinyl acetate, polyethylene, polypropylene, and ethylene-propylene copolymer; glass; or metal. As described above, the “optical member” of the present invention also includes a member (a design film, a decoration film, a surface protective film or the like) for decoration or protection while maintaining visibility of the display device or the input device as an adherend.

As the display device (image display device), examples thereof include a liquid crystal display device, an organic electroluminescence (EL) display device, a plasma display panel (PDP), an electronic paper and the like. As the input device, examples thereof include a touch panel and the like.

Since the double-sided pressure-sensitive adhesive sheet of the present invention is excellent in reworkability at a low temperature, it can be peeled off without applying a great force to the laminated member at a low temperature, and even with a member which tends to be bent (for example, a member in a film shape formed of plastic materials), peeling can be performed without bending. Accordingly, the double-sided pressure-sensitive adhesive sheet of the present invention is preferably an optical double-sided pressure-sensitive adhesive sheet to be used for laminating the plastic optical member (for example, transparent conductive film) on which a film which is easily broken, such as ITO, is provided. In addition, the double-sided pressure-sensitive adhesive sheet of the present invention can be peeled off without cracking even with the member which easily cracks if a force is applied (for example, optical member having high rigidity such as an optical member formed of glass). Therefore, the double-sided pressure-sensitive adhesive sheet of the present invention is preferably an optical double-sided pressure-sensitive adhesive sheet to be used for laminating the optical members formed of glass such as a glass sensor, a glass-made display panel (LCD or the like), and a transparent electrode-attached glass plate of a touch panel.

When the shear storage elastic modulus (23° C.) of the pressure-sensitive adhesive sheet of the present invention is 5.0×10⁵ Pa or less and the shear storage elastic modulus (−50° C.) is 1.0×10⁸ Pa or more, the double-sided pressure-sensitive adhesive sheet of the present invention has a high elastic modulus and is excellent in peeling off. Accordingly, the double-sided pressure-sensitive adhesive sheet of the present invention is excellent in the pressure-sensitive adhesive property at a low temperature and the reworkability at a low temperature (for example, from −50 to −30° C.), and is also excellent in reworkability at a temperature lower than −50° C. (for example, from −100 to −50° C.).

In particular, when the peel force measured by the film T-type peel test is 3 N or less, since the adhesive property with the material which easily cracks becomes small, the double-sided pressure-sensitive adhesive sheet of the present invention can be peeled off from more brittle material. In addition, at a temperature at which the shear storage elastic modulus measured by the dynamic viscoelasticity measurement is 1.0×10⁸ Pa or more, the pressure-sensitive adhesive layer of the present invention obtains a high elastic modulus, and the tackiness is decreased, and thus, peeling is more easily performed.

### (Method of Manufacturing Double-Sided Pressure-Sensitive Adhesive Sheet)

The method of manufacturing the double-sided pressure-sensitive adhesive sheet of the present invention is different depending on the aspect of the pressure-sensitive adhesive composition for forming the pressure-sensitive adhesive layer, and is not particularly limited, and the following methods (1) to (3) are exemplified. The method of forming the pressure-sensitive adhesive layer of each surface of the double-sided pressure-sensitive adhesive sheet may be the same or may be different.

(1) A method of forming a pressure-sensitive adhesive composition layer by coating the pressure-sensitive adhesive composition (for example, active energy-ray-curable pressure-sensitive adhesive composition) on a substrate or a separator, and forming a pressure-sensitive adhesive layer by curing (for example, thermal curing or curing by active energy-ray irradiation such as ultraviolet light) the pressure-sensitive adhesive composition layer.

(2) A method of coating a pressure-sensitive adhesive composition (for example, a solvent-type pressure-sensitive adhesive composition) on a substrate or a separator, and drying and/or curing the pressure-sensitive adhesive composition to form a pressure-sensitive adhesive layer.

(3) A method of further drying the pressure-sensitive adhesive layer manufactured in the above (1).

As the curing method in the above (1) to (3), a method of curing by active energy-ray (particularly a method of curing by ultraviolet ray) is preferable, from the viewpoints of excellent productivity and obtaining thick pressure-sensitive adhesive layer. The curing by active energy-ray may be disturbed by oxygen in the air, and thus, it is preferable to block the oxygen by laminating the separator onto the pressure-sensitive adhesive layer or performing curing under the nitrogen atmosphere.

The method of manufacturing the double-sided pressure-sensitive adhesive sheet of the present invention is not particularly limited, and for example, the method of the above (1) or (3) is preferable, and a method of the above (1) of performing curing by irradiating the pressure-sensitive adhesive composition layer with ultraviolet ray is more preferable.

In the method for manufacturing the double-sided pressure-sensitive adhesive sheet of the present invention, coating may be performed by a known coating method and, a general coater such as a gravure roll coater, a reverse roll coater, a kiss roll coater, a dip roll coater, a bar coater, a knife coater, a spray coater, a comma coater or a direct coater can be used.

### (2) Laminate

The laminate of the present invention is a laminate obtained by laminating the double-sided pressure-sensitive adhesive sheet of the present invention on the optical member. Among them, it is preferable that the surface of the pressure-sensitive adhesive layer of the double-sided pressure-sensitive adhesive sheet of the present invention be laminated on the optical member. That is, in the case where the both surfaces (both-surface layer) of the double-sided pressure-sensitive adhesive sheet of the present invention are the pressure-sensitive adhesive layer of the present invention, at least one pressure-sensitive adhesive layer of the present invention may be laminated on the optical member, and in the case where only one surface (surface layer) of the double-sided pressure-sensitive adhesive sheet of the present invention is the pressure-sensitive adhesive layer of the present invention, the pressure-sensitive adhesive layer of the present invention is preferably laminated on the optical member.

Among the double-sided pressure-sensitive adhesive sheets of the present invention, the pressure-sensitive adhesive layer configuring at least one surface (surface layer) may be laminated on the optical member, and the adherend on which the pressure-sensitive adhesive layer configuring the other surface layer is laminated, may be the optical member or the other member.

(3) Method of Peeling Plate

The method of peeling the plate of the present invention is a method for peeling two plates laminated through the double-sided pressure-sensitive adhesive sheet described above, and is a method of peeling the plate, the method including peeling at least one plate of the two plates, at a temperature at which the shear storage elastic modulus of the pressure-sensitive adhesive layer of the double-sided pressure-sensitive adhesive sheet, which is measured by the dynamic viscoelasticity measurement, is 1.0×10⁸ Pa or more (for example, preferably from 1.0×10⁸ to 1.0×10¹⁰ Pa, more preferably from 1.0×10⁸ to 5.0×10⁹ Pa, and even more preferably from 1.0×10⁸ to 1.0×10⁹ Pa).

In this description, the method of peeling the plate of the present invention may be referred to as the “peeling method of the present invention”.

The temperature at which the shear storage elastic modulus of the pressure-sensitive adhesive layer of the present invention, which is measured by the dynamic viscoelasticity measurement, is 1.0×10⁸ Pa or more is not particularly limited, and for example, may be −30° C. or less (for example, from −50° C. to −30° C.)

In the pressure-sensitive adhesive layer of the present invention, the shear storage elastic modulus tends to become high if the temperature becomes low, and accordingly, the temperature, at which the shear storage elastic modulus is 1.0×10⁸ Pa or more, is equal to or lower than the temperature, at which the shear storage elastic modulus measured by the dynamic viscoelasticity measurement becomes 1.0×10⁸ Pa.

The peeling method of the present invention is not particularly limited, and examples thereof include a method of performing the peeling by applying a force to at least one plate of two laminated plates at least in a normal direction of the plate, a method of performing the peeling by pulling two laminated plates in a thickness direction (method of performing the peeling by pulling the plates in a direction perpendicular to the adhesive surface of the double-sided pressure-sensitive adhesive sheet of the present invention and the plate), a method of performing the peeling by moving the laminated two plates relatively parallel with each other, a method of moving at least one of the two laminated plates so that a virtual linear line specified in the adhesive surface of the double-sided pressure-sensitive adhesive sheet of the present invention and one plate and a virtual linear line specified in the adhesive surface of the double-sided pressure-sensitive adhesive sheet of the present invention and the other plate, which are parallel to each other, could be in a twisted positional relationship (method of moving at least one of two plates so that one of the pressure-sensitive adhesive surface side of the double-sided pressure-sensitive adhesive sheet of the present invention and the other pressure-sensitive adhesive surface side of the double-sided pressure-sensitive adhesive sheet of the present invention are twisted). Among them, the method of performing the peeling by applying a force to at least one plate of two laminated plates at least in a normal direction of the plate is preferable.

The “normal direction of the plate” refers to a direction perpendicular to the surface of the plate (surface of the plate on which the double-sided pressure-sensitive adhesive sheet of the present invention is laminated).

In addition, “applying a force at least in the normal direction of the plate” refers to applying a force containing a component at least in the normal direction of the plate. That is, it means that the component in the normal direction exists, when the applied force is divided. That is to say, the case of applying a force only in the normal direction of the plate and the case of applying a force in the direction diagonal with respect to the surface of the plate are included, and the case of applying a force only in the direction parallel with the surface of the plate (for example, the case of moving the two plates parallel with each other without applying a force in the normal direction or the case of twisting the two plates without applying a force in the normal direction) is not included.

In addition, “moving the two plates relatively parallel to each other” is meant to move at least one of the two plates, while substantially maintaining the distance of the opposing surfaces of the two plates laminated through the double-sided pressure-sensitive adhesive sheet of the present invention constant. For example, in the case where the two plates are in flat plate shape, at least one of the two plates is moved while maintaining a parallel relationship of the two plates (flat plates).

### (Peeling Temperature)

In the peeling method of the present invention, the temperature when the plate is peeled (which may be referred to as a “peeling temperature”) is a temperature at which the shear storage elastic modulus of the pressure-sensitive adhesive layer of the double-sided pressure-sensitive adhesive sheet of the present invention, which is measured by the dynamic viscoelasticity measurement, is 1.0×10⁸ Pa or more, and preferably at a temperature at which the shear storage elastic modulus is 4.0×10⁸ Pa or more. At the temperature at which the shear storage elastic modulus is 1.0×10⁸ Pa or more, since the cohesive force of the pressure-sensitive adhesive layer becomes high, the force (pressure-sensitive adhesive force of the pressure-sensitive adhesive layer of the present invention) for attaching the pressure-sensitive adhesive layer of the present invention to the plate is weakened, and the pressure-sensitive adhesive layer of the present invention is hardly deformed or twisted. Thus, at least one plate of the two plates can be easily peeled in a short period without giving any substantial force (load) that may cause a large strain (deformation) leading to break or crack.

In the peeling method of the present invention, the plate and the double-sided pressure-sensitive adhesive sheet are separated on the interface of the pressure-sensitive adhesive layer of the present invention and the plate. Accordingly, the double-sided pressure-sensitive adhesive sheet of the present invention does not remain on both of the two plates (both plates) after the separation, and the double-sided pressure-sensitive adhesive sheet of the present invention is attached only to one plate, and the double-sided pressure-sensitive adhesive sheet of the present invention is hardly attached to the other plate. That is, the two plates are separated into the plate to which the double-sided pressure-sensitive adhesive sheet of the present invention is attached, and the plate in which the double-sided pressure-sensitive adhesive sheet of the present invention remains in a small amount. Thus, in the peeling method of the present invention, it is preferred that the pressure-sensitive adhesive layer of the present invention is laminated to a plate desired to be reused (a plate in which the pressure-sensitive adhesive layer is desired to remain in a small amount or an optical member desired to be reused) among the two plates, and the peeling of a laminate having such a configuration is performed.

In addition, in the peeling method of the present invention, since the cohesive force of the pressure-sensitive adhesive layer of the present invention when the plate is peeled is high, and the pressure-sensitive adhesive force with respect to the plate is weak, the two plates can be separated due to the separated portion generated by only peeling a part of the adhesive surface of the pressure-sensitive adhesive layer of the present invention and one plate. Accordingly, it is possible to easily peel two plates with a small force, in a short time.

In addition, in the peeling method of the present invention, since it is possible to peel the plates with a weak force without giving any substantial force (load) that may cause a large strain (deformation) leading to break or crack, the method can be used even in the case of peeling high-rigidity plates such as glass plates or thin plates.

### (Method of Applying Force at Least in Normal Direction of Plate)

In the peeling method of the present invention, the method of applying a force at least in the normal direction of the plate is not particularly limited, and examples thereof include a method of inserting a wedge-shaped tip portion of a tool from the side surfaces of the double-sided pressure-sensitive adhesive sheets of the laminate in which the two plates are laminated through the double-sided pressure-sensitive adhesive sheet;

a method of pulling at least one plate of the two plates laminated through the double-sided pressure-sensitive adhesive sheet by a wire or a kite string; a method of fixing at least one plate of the two plates laminated through the double-sided pressure-sensitive adhesive sheet to a fixing plate and pulling the fixing plate; a method of attaching a sucker to at least one of the two plates laminated through the double-sided pressure-sensitive adhesive sheet and pulling the sucker; a method of pouring a solution which can expand by freezing of water or the like into the gap between the double-sided pressure-sensitive adhesive sheet and the plates laminated through the double-sided pressure-sensitive adhesive sheet, or into the double-sided pressure-sensitive adhesive sheet, and freezing the solution poured; a method of applying impact by hitting or dropping down the two plates laminated through the double-sided pressure-sensitive adhesive sheet; and a method of combining at least two or more methods selected from the above-mentioned methods.

Among them, from the viewpoint of easily applying a force in a short time, the method of inserting a wedge-shaped tip portion of a tool from the side surfaces of the double-sided pressure-sensitive adhesive sheets of the laminate in which the two plates are laminated through the double-sided pressure-sensitive adhesive sheet (referred to as “force applying method A”), the method of pulling at least one plate of the two plates laminated through the double-sided pressure-sensitive adhesive sheet by a wire or a kite string (referred to as “force applying method B”), and the method of fixing at least one plate of the two plates laminated through the double-sided pressure-sensitive adhesive sheet to a fixing plate and pulling the fixing plate (referred to as “force applying method C”) are preferable, and the force applying method A is particularly preferable.

### (Force Applying Method A)

In the force applying method A, the wedge-shaped tip portion of the tool is not particularly limited as long as it has a shape (wedge-shape) to be gradually thicker from one end to the other end, and for example, the cross section of the tip portion (cross section in the direction from one end to the other end) is approximately an isosceles triangle shape or approximately a right triangle.

The tool having the wedge-shaped tip portion is not particularly limited, and examples thereof include tools formed of metal, plastic, wood, ceramics, or the like, and more concretely, blades such as a chisel, a cutter, and a graver, a spatula, a needle, a pile, and the like can be used. Among them, from the viewpoint of easily applying a force at least in the normal direction of the plate, the metallic tools (particularly, metallic blades) and the plastic tools are preferable.

In the force applying method A, the position where the wedge-shaped tip portion of the tool is inserted is not particularly limited, as long as the tip portion comes in contact with the side surface of the double-sided pressure-sensitive adhesive sheet, and for example, the position may be a boundary portion of the double-sided pressure-sensitive adhesive sheet and the plate (particularly, the boundary portion of the pressure-sensitive adhesive layer of the present invention and one plate).

In the force applying method A, the angle at which the wedge-shaped tip portion of the tool is inserted is not particularly limited, and for example, it is preferable to insert the tip portion so that at least one surface of the surfaces, where the cross section of the tip portion of the tool is a wedge-shape and the pressure-sensitive adhesive surface of the plate, and the double-sided pressure-sensitive adhesive sheet are approximately orthogonal to each other.

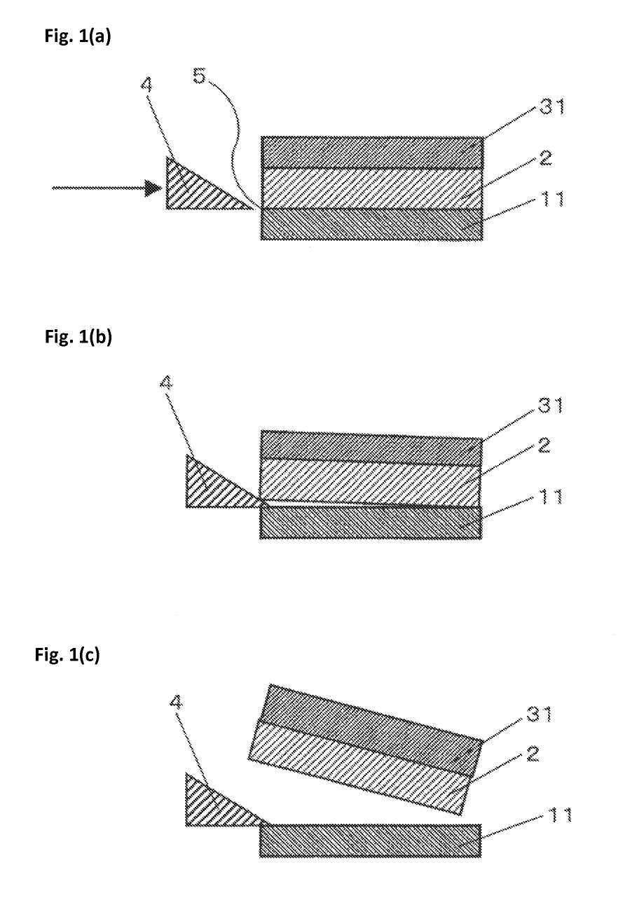

In the force applying method A, the direction in which the wedge-shaped tip portion of the tool is inserted is not particularly limited, and for example, a direction approximately parallel with the plate is preferable. In addition, in the case of inserting the tool having the wedge-shaped tip portion to the double-sided pressure-sensitive adhesive sheet, since the tip portion has a shape to be gradually thicker from the tip to the other end of the portion, it is possible to apply a force at least in the normal direction of the plate (see FIGS. 1(a) to 1(c)) by inserting the tool in a direction parallel with the plate.

In the force applying method A, from the viewpoint of easily performing peeling operation, at least one plate of the two plates laminated through the double-sided pressure-sensitive adhesive sheet may be fixed. The method of fixing the plate is not particularly limited, and for example, a method of fixing the plate with a metal fixing tool which is easily removed, is exemplified.

In the peeling method of the present invention, in the case of applying a force by the force applying method A, it is possible to more easily apply a force at least in the normal direction of the plate and more easily peel the plate.

Hereinafter, preferred detailed aspects of the force applying method A will be shown.

FIGS. 1(a) to 1(c) are a diagram showing an example of a force applying method A. In FIGS. 1(a) to 1(c), reference numeral 11 denotes glass (a) (one plate), reference numeral 2 denotes the double-sided pressure-sensitive adhesive sheet of the present invention, reference numeral 31 denotes glass (b) (the other plate), reference numeral 4 denotes a chisel (tool having the wedge-shaped tip portion), and reference numeral 5 denotes the boundary portion of the double-sided pressure-sensitive adhesive sheet of the present invention and the glass (a). The arrow in the right direction in the FIG. 1(a) denotes a direction of inserting the chisel 4.

In the method of FIGS. 1(a) to 1(c), the chisel 4 is inserted to the boundary portion 5 of the double-sided pressure-sensitive adhesive sheet of the present invention and the glass (a) in the direction parallel with the plate, and the force is applied at least in the normal direction of the glass (b) 31 (FIGS. 1(a) and 1(b)) to peel the glass (a) 11 and the glass (b) 31 in the boundary portion 5 of the glass (a) 11 and the double-sided pressure-sensitive adhesive sheet 2 of the present invention (FIG. 1(c)).

### (Force Applying Method B)

In the force applying method B, the direction of pulling the wire or the kite string is not particularly limited, as long as the force is applied at least in the normal direction of one plate of the two plates laminated through the double-sided pressure-sensitive adhesive sheet of the present invention, and for example, the normal direction of the plate or the direction diagonal to the surface of the plate is exemplified.

In the force applying method B, from the viewpoint of easily performing the peeling operation, at least one plate of the two plates laminated through the double-sided pressure-sensitive adhesive sheet is fixed, and then, the wire or the kite string may be pulled. The method of fixing the plate is not particularly limited, and for example, a method of fixing the plate with a metallic fixing tool which is easily removed is exemplified.

Hereinafter, preferred detailed aspects of the force applying method B are shown.

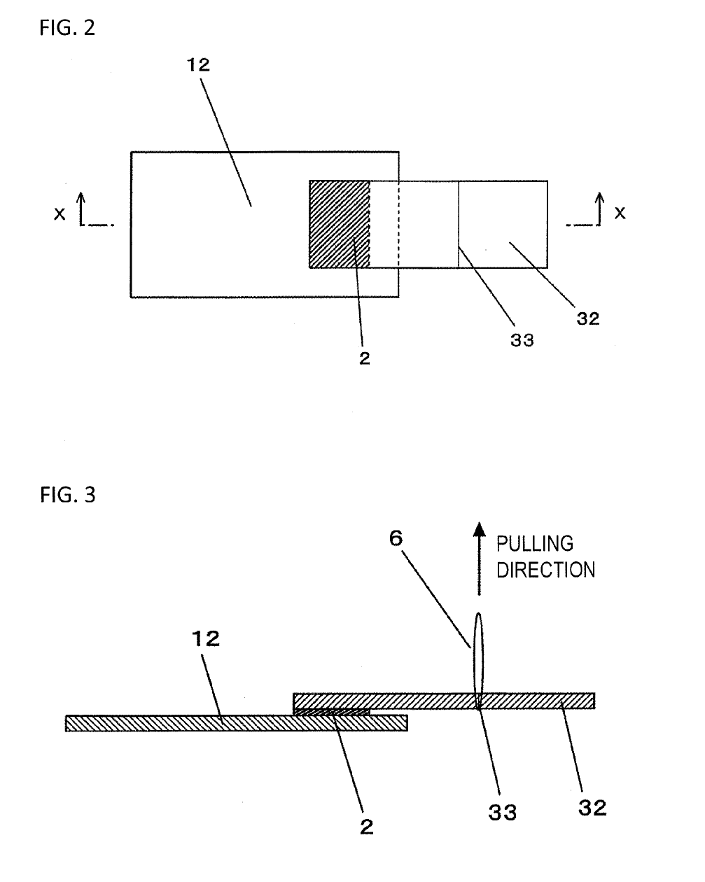

FIGS. 2 and 3 are diagrams showing examples of the force applying method B, wherein FIG. 2 is an explanatory diagram (plan view) showing two plates laminated through the double-sided pressure-sensitive adhesive sheet of the present invention, and FIG. 3 is an explanatory diagram (X-X line-cross sectional view) showing an aspect of hooking with the kite string. In FIGS. 2 and 3, reference numeral 12 denotes a glass plate (c) (one plate), reference numeral 2 denotes the double-sided pressure-sensitive adhesive sheet of the present invention, reference numeral 32 denotes slide glass (d) (the other plate), reference numeral 33 denotes a kite string pulling portion, and reference numeral 6 denotes a kite string. In addition, the arrow in the upper direction in FIG. 3 denotes a direction of pulling the kite string 6.

In the method in FIGS. 2 and 3, by hooking the kite string 6 on the kite string pulling portion 33 of the glass (d) 32 and pulling the kite string, the force is applied in the normal direction of the glass plate (d) 12 to thereby peel the glass plate (c) 12 and the slide glass (d) 32.

(Force Applying Method C) In the force applying method C, the fixing plate is not particularly limited, and examples thereof include a plate (acrylic plate) formed of synthesis resins such as acrylic resins, and metallic plates. Among them, from the viewpoints of the weight (i.e. the fixing plate is not too heavy) and easily pulling the fixing plate, the acrylic plate is preferable.

In the force applying method C, at least one plate of the two plates laminated through the double-sided pressure-sensitive adhesive sheet of the present invention may be fixed to the fixing plate, and for example, only one plate thereof may be fixed to the fixing plate, or the two plates may be fixed to the fixing plates. Among them, from the viewpoint of easily peeling the plate, the two plates are preferably fixed to the fixing plates. In the case of fixing the two plates to the fixing plates, the fixing plates may be the same or may be different from each other.

In the force applying method C, from the viewpoint of easily grabbing the fixing plate when the plate is peeled, the fixing plate is preferably larger than the fixed plate (i.e. the fixing plate has a portion protruded from the fixed plate). In the case of fixing the two plates to the fixing plates, the two fixing plates may be larger than the fixed plates, respectively.

The thickness of the fixing plate is not particularly limited, and from the viewpoints of the weight (i.e. the fixing plate is not too heavy) and easily pulling the fixing plate, the thickness thereof is preferably from 0.5 to 10 mm and more preferably 1 to 5 mm.

In the force applying method C, the method of fixing the plate to the fixing plate is not particularly limited, and for example, a method of laminating the fixing plate using a pressure-sensitive adhesive sheet for fixing is exemplified.

The pressure-sensitive adhesive sheet for fixing is not particularly limited, and examples thereof include the pressure-sensitive adhesive sheet (particularly, double-sided pressure-sensitive adhesive sheet) having the pressure-sensitive adhesive layer for fixing formed of a known pressure-sensitive adhesive such as an acrylic pressure-sensitive adhesive, rubber-based pressure-sensitive adhesive, polyolefine-based pressure-sensitive adhesive, vinyl alkyl ether-based pressure-sensitive adhesive, silicone-based pressure-sensitive adhesive, polyester-based pressure-sensitive adhesive, polyamide-based pressure-sensitive adhesive, urethane-based pressure-sensitive adhesive, fluorine-based pressure-sensitive adhesive, and epoxy-based pressure-sensitive adhesive. The pressure-sensitive adhesive to form the pressure-sensitive adhesive layer for fixing of the pressure-sensitive adhesive sheet for fixing may be used alone or in combination of two or more kinds thereof.

In the force applying method C, the pulling direction of the fixing plate is not particularly limited, as long as the force is applied at least in the normal direction of one plate of the two plates laminated through the double-sided pressure-sensitive adhesive sheet of the present invention, and for example, the normal direction of the plate or the direction diagonal with respect to the surface of the plate is exemplified.

Hereinafter, preferred detailed aspect of the force applying method C is shown.

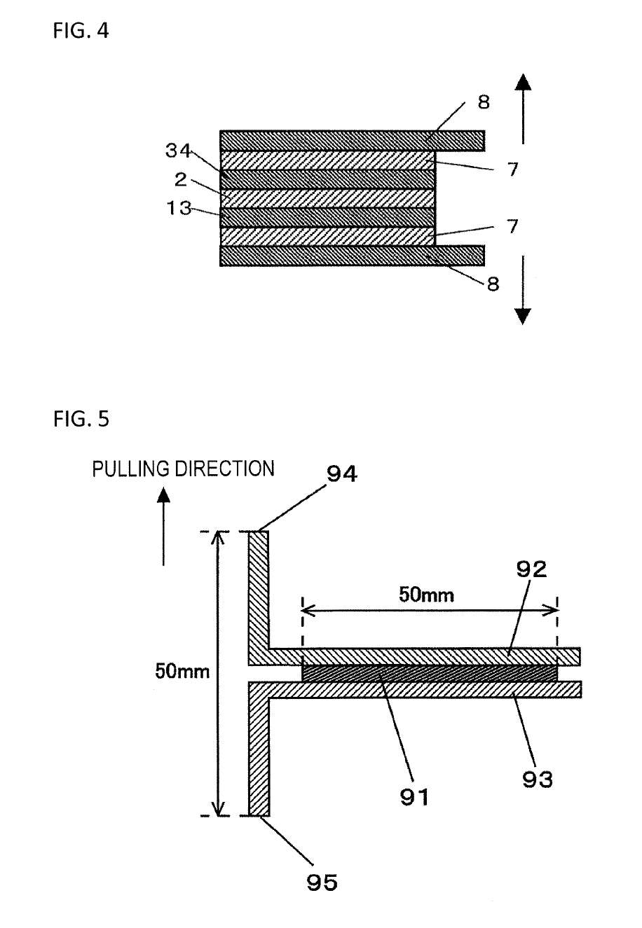

FIG. 4 is a diagram showing an example of the force applying method C. In FIG. 4, reference numeral 13 denotes glass (e) (one plate), reference numeral 2 denotes the double-sided pressure-sensitive adhesive sheet of the present invention, reference numeral 34 denotes glass (f) (the other plate), reference numeral 7 denotes a pressure-sensitive adhesive sheet for fixing, and reference numeral 8 denotes an acrylic plate (fixing plate). In the method in FIG. 4, the acrylic plate 8 is larger than the glass (e) 13, the double-sided pressure-sensitive adhesive sheet 2 of the present invention, and the glass (f) 34, and has a protruded portion, it is possible to grab and pull the protruded portion.

In the peeling method of the present invention, the degree of the force applied at least in the normal direction of the plate is not particularly limited, and for example, is preferably from 0.5 to 18 N and more preferably from 1 to 15 N. The force of the component in the normal direction, among the force containing the component at least in the normal direction of the plate, preferably satisfies the above range.

In the peeling method of the present invention, in the case of peeling two plates by applying the force to one plate of the two plates laminated through the double-sided pressure-sensitive adhesive sheet of the present invention (for example, force applying method A or force applying method B), in the two plates after separation, the double-sided pressure-sensitive adhesive sheet of the present invention may remain on the plate to which the force is applied, and the double-sided pressure-sensitive adhesive sheet of the present invention may almost not remain (no remaining adhesiveness or small remaining adhesiveness) on the other plate to which the force is not applied (see FIG. 1(c)). In addition, the double-sided pressure-sensitive adhesive sheet may remain on the plate to which the force is not applied, and the double-sided pressure-sensitive adhesive sheet may almost not remain (no remaining adhesiveness or small remaining adhesiveness) on the other plate to which the force is applied.

### (Plate)

The plate is not particularly limited, and examples thereof include plates formed of glass; plastics such as an acrylic resin, polycarbonate, and polyethylene terephthalate; metal such as stainless steel or aluminum; or combination thereof. Among them, according to the peeling method of the present invention, the plastic plate or glass having high rigidity is preferable, and the glass is particularly preferable, since peeling can be performed without breaking or cracking even when the plate having high rigidity which is hard to be subjected to peeling separation is used.

The optical member is preferable for the plate, due to high demand of the reworkability. Examples of the optical member include the optical members described above.

Among them, the plate which is the optical member having high rigidity is preferable, and the optical member formed of glass is particularly preferable. Concretely, the plates having the optical characteristics formed of glass such as a glass sensor, a glass-made display panel (LCD or the like), and the transparent electrode-attached glass plate of a touch panel, are preferable, and the glass sensor and the glass-made display panel are more preferable.

The laminate in which the two plates are laminated through the double-sided pressure-sensitive adhesive sheet of the present invention may be obtained by laminating the same plates or may be obtained by laminating different plates.

The area of the plate is not particularly limited, and for example, is preferably more than 0 and 20,000 cm² or less, and more preferably from 1 to 15,000 cm². The area thereof is even more preferably from 5 to 10,000 cm², more preferably from 10 to 800 cm², and more preferably from 20 to 500 cm². The two laminated plates may have the same areas or may have the different areas.

The thickness of the plate is not particularly limited, and for example, is preferably from 0.1 to 5 mm, more preferably from 0.3 to 3 mm, and even more preferably from 0.5 to 2 mm. At least one plate of the plates may fall in the range described above. The two laminated plates may have the same thickness or the different thickness. According to the peeling method of the present invention, even when the thin plate which is hard to be subjected to the peeling separation is used, the plates can be peeled without giving any substantial force (load) that may cause a large strain (deformation) leading to break or crack, and thus, for example, even when the plastic plates or glass which is thin (for example, thickness of 1 mm or less) and has high rigidity, peeling can be performed without causing any problems such as breaking or cracking.

According to the peeling method of the present invention, in the two plates laminated through the double-sided pressure-sensitive adhesive sheet of the present invention, even if at least one of the two plates is a member which is easily bent, or a plate which is thin and is poor in flexibility, the peeling can be performed without giving any substantial force (load) that may cause breaking, cracking, and strain (deformation) to the plate.

### EXAMPLES

Hereinafter, the present invention is described in more detail with reference to the following Examples and Comparative Examples; however, the present invention is not limited by these Examples. The blending composition of the monomer components (the kind and the amount of the monomer), and the blending composition of the pressure-sensitive adhesive composition (the kind and the amount of the components) were shown in Table 1.

### Example 1

A mixture prepared by mixing 70 parts by weight of 2-ethylhexyl acrylate (2EHA), 20 parts by weight of N,N-dimethyl acrylamide (DMAA), and 10 parts by weight of isobornyl acrylate (IBXA) was further mixed with 0.05 parts by weight of 1-hydroxy-cyclohexyl-phenyl-ketone (trade name “IRGACURE 184” manufactured by BASF Japan) and 0.05 parts by weight of 2,2-dimethoxy-1,2-diphenylethane-1-on (trade name “IRGACURE 651” manufactured by BASF Japan), both serving as a photopolymerization initiator, and the resulting mixture was put into a four-necked flask, and the resulting mixture was irradiated with UV ray until the viscosity (BH viscosimeter, No. 5 rotor, 10 rpm, temperature 30° C.) thereof could reach about 15 Pa·s under the nitrogen atmosphere, to subject to photo polymerization, thereby preparing partially polymerized monomer syrup (partially polymerized produce of the monomer component).

To 100 parts by weight of this partially polymerized monomer syrup, 0.035 parts by weight of 1,6-hexanediol diacrylate (HDDA, polyfunctional monomers), 0.3 parts by weight of a silane coupling agent (trade name “KBM403” manufactured by Shin-Etsu Chemical Industry Co., Ltd.), 0.05 parts by weight of 1-hydroxy-cyclohexyl-phenyl-ketone (trade name “IRGACURE 184” manufactured by BASF Japan) as photopolymerization initiators (additional initiators), and 0.05 parts by weight of 2,2-dimethoxy-1,2-diphenylethane-1-on (trade name “IRGACURE 651” manufactured by BASF Japan) as photopolymerization initiators (additional initiators) were evenly mixed, thereby preparing a pressure-sensitive adhesive composition.

The pressure-sensitive adhesive composition was applied on a surface of the release film (trade name “MRF #38” manufactured by Mitsubishi Plastics Inc.) which has been subjected to release treatment so that the thickness could be 50 μm, thereby forming a pressure-sensitive adhesive composition layer. Next, the other surface of the pressure-sensitive adhesive composition layer and a surface of the release film (trade name “MRN #38” manufactured by Mitsubishi Plastics Inc.) which has been subjected to release treatment were laminated to each other, the UV ray irradiation under the conditions of the illuminance of 4 mW/cm² and the light intensity of 1,200 mJ/cm² were performed t photo-cure the same, thereby forming a pressure-sensitive adhesive layer, and a double-sided pressure-sensitive adhesive sheet was prepared.

### Examples 2 to 5 and Comparative Examples 1 and 2

A pressure-sensitive adhesive composition and a double-sided pressure-sensitive adhesive sheet were prepared in the same manner as in Example 1 except that the kind and amount of the monomer components, and the thickness of the pressure-sensitive adhesive composition layer were changed as in Table 1.

### (Evaluation)

Each of the double-sided pressure-sensitive adhesive sheet produced in Examples and Comparative Examples was evaluated for the gel fraction, film T-type peel test, and the shear storage elastic modulus. The evaluation methods are shown below. The evaluation results are shown in Table 1.

### (1) Gel Fraction

The measurement of the gel fraction was performed according to the “Method of measuring gel fraction” described above.

### (2) Film T-Type Peel Test

### (Manufacturing of Evaluation Sample)

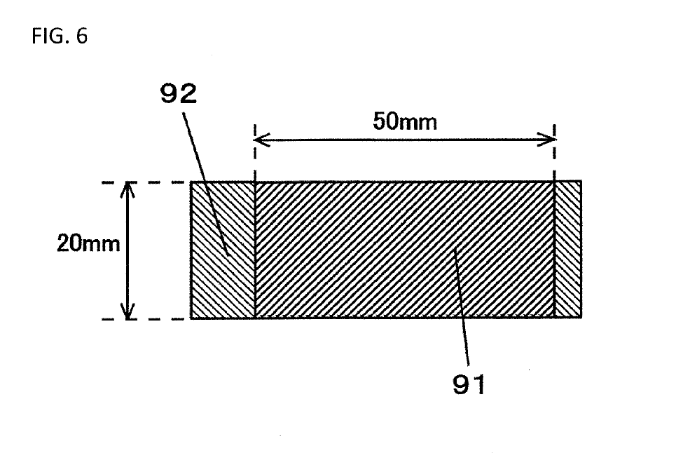

FIG. 5 is an explanatory view (cross-sectional view) showing a test sample used in a film T-type peel test. FIG. 6 is an explanatory view (plan view) showing a test sample used in a film T-type peel test.

A sheet piece (size: 50 mm of length×20 mm of width) was cut from the double-sided pressure-sensitive adhesive sheet produced in Examples and Comparative Examples. One release film (MRN #38) was peeled from the cut sheet piece, and then, one pressure-sensitive adhesive surface was laminated to a surface of a polyethylene terephthalate film (PET film) (i) 92 (trade name “A4100” manufactured by Toyobo Co., Ltd., size: 150 mm of length×20 mm of width, thickness 100 μm). The other release film (MRF #38) was peeled, and then, the other pressure-sensitive adhesive surface was laminated to a surface of a PET film (ii) 93 (trade name “A4100” manufactured by Toyobo Co., Ltd., size: 150 mm of length×20 mm of width, thickness 100 μm). Then, a test sample (FIGS. 5 and 6) in which the PET film (i) 92 and the PET film (ii) 93 were laminated through the sheet piece 91 was prepared. Then, an evaluation sample having a configuration of the PET film (i) 92/the pressure-sensitive adhesive sheet (sheet piece) 91/PET film (ii) 93 was obtained.

### <Film T-Type Peel Test>

The evaluation sample was put into an autoclave, and the sample was subjected to an autoclave treatment under the condition of a temperature of 50° C. and a pressure of 5 atm for 15 minutes. After the autoclave treatment, the evaluation sample was taken out of the autoclave, followed by allowing to stand for 30 minutes under the environment of a temperature at −50° C. Next, the end portion 94 of the PET film (i) and the end portion 95 of the PET film (ii) were fixed to the tensile tester by fastner (gripper) under the environment of a temperature at −50° C., and the end portion 94 of the PET film (i) was pulled in the pulling direction shown in FIG. 5 (arrow direction shown in FIG. 5) under the following conditions, thereby peeling the PET film (i) 92 and the PET film (ii) 93. Peeling was performed over 50 mm of the length of the test piece, and the maximum load when it was peeled was measured. The test was performed three times (n=3), and the average value was set to a film T-type peel force (N).

Device (tensile tester): trade name “AUTOCLAVE” manufactured by Shimadzu Corporation

Sample width: 20 mm

Tensile speed: 300 mm/min

Tensile direction: CD direction (the arrow direction shown in FIG. 5, the direction perpendicular to the adhesive surface of the sheet piece 91 and the PET film (i) 92 and the PET film (ii) 93)

Number of repeating: n=3

In addition, the reworkability was evaluated the case where film T-type peel force is 3 N or less as “excellent peeling property (A)”, and the case where the film T-type peel force is larger than 3 N as “poor peeling property (B)”.

The film T-type peel force in the film T-type peel test and the evaluation results of the reworkability were shown in columns of “Film T-type peel force (N)” and “Peeling property evaluation” in Table 1.

### (3) Shear Storage Elastic Modulus

The measurement of the shear storage elastic modulus was performed according to the “Method of dynamic viscoelasticity measurement” described above.

TABLE 1

| | | | | | | | | Comparative | Comparative |
|---|---|---|---|---|---|---|---|---|---|
| | | | Example 1 | Example 2 | Example 3 | Example 4 | Example 5 | Example 1 | Example 2 |
| Monomer | C₁₋₉ alkyl (meth)acrylate | 2EHA | 70 | 68 | 90 | 80 | 70 | 100 | 100 |
| components | (parts by weight) | | | | | | | | |
| | Alicyclic monomer | IBXA | 10 | | | | | | 5 |
| | (parts by weight) | | | | | | | | |
| | Polar group-containing | NVP | | 14.5 | | | | | |
| | monomer | HEA | | 17.5 | | | | | 0.5 |
| | (parts by weight) | DMAA | 20 | | | | | | |
| | | DEAA | | | | | 30 | | |
| | | ACMO | | | | 20 | | | |
| | | AA | | | 10 | | | | |

| | | | | | | | |
|---|---|---|---|---|---|---|---|
| Thickness of pressure-sensitive adhesive | | | | | | | |
| composition layer (gm) | 50 | 175 | 175 | 50 | 50 | 50 | 175 |
| Gel fraction (%) | 79 | 90 | 65 | 71 | 73 | 76 | 68 |
| Film T-type peel force (N) | 0.44 | 0.21 | 1.00 | 1.63 | 0.93 | 3.65 | 7.35 |
| Peeling property evaluation | A | A | A | A | A | B | B |
| Shear storage elastic modulus (23° C.) | 1.2 × 10⁵ | 2.1 × 10⁵ | 1.8 × 10⁵ | 1.0 × 10⁵ | 7.9 × 10⁴ | 1.1 × 10⁵ | 4.2 × 10⁴ |
| Shear storage elastic modulus (−50° C.) | 6.87 × 10⁸ | 4.36 × 10⁹ | 1.07 × 10⁸ | 2.27 × 10⁸ | 4.71 × 10⁸ | 9.86 × 10⁷ | 9.79 × 10⁶ |

The abbreviations in Table 1 are as follows:
2EHA: 2-ethylhexyl acrylate
IBXA: isobornyl acrylate
NVP: N-vinyl-2-pyrrolidone
HEA: 2-hydroxyethyl acrylate
DMAA: N,N-dimethyl acrylamide
DEAA: N,N-diethyl acrylamide
ACMO: acryloyl morpholine
AA: acrylic acid

While the invention has been described in detail and with reference to specific embodiments thereof, it will be apparent to one skilled in the art that various changes and modifications can be made therein without departing from the spirit and scope thereof.

This application is based on Japanese Patent Application No. 2012-189612 filed on Aug. 30, 2012, the entire subject matter of which is incorporated herein by reference.

### DESCRIPTION OF REFERENCE NUMERALS AND SIGNS

11: Glass (a) (one plate)
12: Glass plate (c) (one plate)
13: Glass (e) (one plate)
2: Double-sided pressure-sensitive adhesive sheet of the present invention
31: Glass (b) (the other plate)
32: Slide glass (d) (the other plate)
33: Kite string pulling portion
34: Glass (f) (the other plate)
4: Chisel (tool having the edge-shaped tip portion)
5: Boundary portion of the double-sided pressure-sensitive adhesive sheet of the present invention and the glass (a)
6: Kite string
7: Pressure-sensitive adhesive sheet for fixing
8: Acrylic plate (fixing plate)
91: Sheet piece (pressure-sensitive adhesive sheet)
92: Polyethylene terephthalate film (i) (PET film (i))
93: Polyethylene terephthalate film (ii) (PET film (ii))
94: End portion of polyethylene terephthalate film (i) (end portion of PET film (i))
95: End portion of polyethylene terephthalate film (ii) (end portion of PET film (ii))

What is claimed is:

1. A double-sided pressure-sensitive adhesive sheet, comprising a pressure-sensitive adhesive layer containing an acrylic polymer formed of a component comprising, as an essential monomer component, an alkyl (meth)acrylate having an alkyl group having 9 or less carbon atoms,
wherein a shear storage elastic modulus at 23° C. of the pressure-sensitive adhesive layer, which is measured by dynamic viscoelasticity measurement, is 5.0×10⁵ Pa or less, and a shear storage elastic modulus at −50° C. of the pressure-sensitive adhesive layer, which is measured by dynamic viscoelasticity measurement, is 1.0×10⁸ Pa or more,
wherein the component to form the acrylic polymer comprises, based on a total amount (100 wt %) of the monomer component, 65 to 70 wt % of the alkyl (meth)acrylate having an alkyl group having 9 or less carbon atoms, 15 to 20 wt % of a hydroxyl group-containing monomer, and 10 to 15 wt % of a nitrogen atom-containing monomer.

2. The double-sided pressure-sensitive adhesive sheet according to claim 1, wherein the shear storage elastic modulus at 23° C. of the pressure-sensitive adhesive layer, which is measured by dynamic viscoelasticity measurement, is 1.0×10⁴ Pa or more.

3. The double-sided pressure-sensitive adhesive sheet according to claim 1, wherein the shear storage elastic modulus at −50° C. of the pressure-sensitive adhesive layer, which is measured by dynamic viscoelasticity measurement, is 1.0×10¹⁰ Pa or less.

4. The double-sided pressure-sensitive adhesive sheet according to claim 1, wherein a peel force measured by the following film T-type peel test is 3 N or less:
Film T-type peel test: one pressure-sensitive adhesive surface of the double-sided pressure-sensitive adhesive sheet (size of 150 mm length×20 mm width) and a surface of a polyethylene terephthalate film (size of 150 mm length×20 mm width) are laminated, and the other pressure-sensitive adhesive surface of the double-sided pressure-sensitive adhesive sheet and a surface of a polyethylene terephthalate film (size of 150 mm length×20 mm width) are laminated, thereby preparing a test piece having a configuration of the polyethylene terephthalate film/the double-sided pressure-sensitive adhesive sheet/the polyethylene terephthalate film; the test piece is treated under the conditions of a temperature of 50° C. and a pressure of 5 atm for 15 minutes, and then, the test piece is allowed to stand for 30 minutes under the environment of a temperature of −50° C.; and after that, the test piece is subjected to T-type peel under the conditions of a temperature of −50° C. and a tensile speed of 300 mm/min, to measure the peel force.

5. The double-sided pressure-sensitive adhesive sheet according to claim 4, wherein the peel force measured by the film T-type peel test is 0.01 N or more

6. The double-sided pressure-sensitive adhesive sheet according to claim 4, which is capable of being peeled from an adherend by the peel force of 0.01 to 3 N, which is measured by the film T-type peel test, at a temperature, at which the shear storage elastic modulus of the pressure-sensitive adhesive layer, which is measured by the dynamic viscoelasticity measurement, is 1.0×10⁸ Pa or more.

7. The double-sided pressure-sensitive adhesive sheet according to claim 4, which is capable of being peeled from an adherend by the peel force of 0.01 to 3 N, which is measured by the film T-type peel test, at a temperature, at which the shear storage elastic modulus of the pressure-sensitive adhesive layer, which is measured by the dynamic viscoelasticity measurement, is 1.0×10⁸ Pa or more and 1.0×10¹⁰ Pa or less.

8. A laminate, comprising the double-sided pressure-sensitive adhesive sheet according to claim 1 and an optical member, wherein the double-sided pressure-sensitive adhesive sheet is laminated to the optical member.

9. A method for peeling two plates laminated through the double-sided pressure-sensitive adhesive sheet according to claim 1, the method comprising
peeling at least one plate of the two plates at a temperature, at which the shear storage elastic modulus of the pressure-sensitive adhesive layer, which is measured by the dynamic viscoelasticity measurement, is 1.0×10⁸ Pa or more.

10. The method according to claim 9, wherein the shear storage elastic modulus at 23° C. of the pressure-sensitive adhesive layer, which is measured by dynamic viscoelasticity measurement, is 1.0×10⁴ Pa or more.

11. The method according to claim 9, wherein the shear storage elastic modulus at −50° C. of the pressure-sensitive adhesive layer, which is measured by dynamic viscoelasticity measurement, is 1.0×10¹⁰ Pa or less.

12. The method according to claim 9, wherein the method comprises peeling at least one plate of the two plates at a temperature, at which the shear storage elastic modulus of the pressure-sensitive adhesive layer, which is measured by the dynamic viscoelasticity measurement, is 1.0×10⁸ Pa or more and 1.0×10¹⁰ Pa or less.
